(19) United States
(12) Patent Application Publication
(10) Pub. No.: US 2012/0295148 A1
(43) Pub. Date: Nov. 22, 2012

(54) ELECTROLYTIC SOLUTION FOR SECONDARY BATTERY, SECONDARY BATTERY, ELECTRONIC APPLIANCE, POWER TOOL, ELECTRIC VEHICLE, AND ELECTRIC POWER STORAGE SYSTEM

(75) Inventors: Kentaro Yoshimura, Fukushima (JP); Tadahiko Kubota, Kanagawa (JP)

(73) Assignee: SONY CORPORATION, Tokyo (JP)

(21) Appl. No.: 13/467,430

(22) Filed: May 9, 2012

(30) Foreign Application Priority Data
May 17, 2011 (JP) 2011-110723

(51) Int. Cl. H01M 10/0564; H01M 2/16

(52) U.S. Cl. 429/144; 429/188; 429/200; 429/329

(57) ABSTRACT

A secondary battery includes: a positive electrode, a negative electrode, and an electrolytic solution containing a nitrogen-containing aromatic compound, wherein the nitrogen-containing compound contains an aromatic skeleton containing one or two or more aromatic rings and one or two or more nitrogen-containing functional groups bonded to the one or two or more aromatic rings and represented by the following formula (1)

(YX═N— (1)

wherein X represents C or P; Y represents a group constituted of one kind or two or more kinds of elements selected from the group consisting of H, C, N, O, S, F, Cl, Br, and I, provided that arbitrary two or more of X and Y may be bonded to each other to form a ring structure; and z is 2 or 3.

### FIELD

The present technology relates to an electrolytic solution for secondary battery, a secondary battery using the electrolytic solution for secondary battery, and an electronic appliance, a power tool, an electric vehicle, and an electric power storage system, each of which uses the secondary battery.

### BACKGROUND

In recent years, electronic appliances represented by a mobile phone, a personal digital assistant (PDA), etc. have widely spread, and it is strongly demanded to realize even more downsizing, weight reduction, and long life thereof. Following this, the development of, as an electric power source, a battery, in particular, a secondary battery which is small-sized and lightweight and from which a high energy density is obtainable, is being advanced. Recently, as for this secondary battery, applications to not only the foregoing electronic appliances but various uses represented by power tools such as power drills, electric vehicles such as electric cars, and electric power storage systems such as household electric power servers are also investigated.

As the secondary battery, those utilizing a variety of charge and discharge principles are widely proposed. Above all, a lithium ion secondary battery utilizing intercalation and deintercalation of a lithium ion is regarded as promising. This is because a higher energy density than that of a lead battery or a nickel-cadmium battery or the like is obtainable.

The secondary battery is equipped with an electrolytic solution together with a positive electrode and a negative electrode, and the positive electrode and the negative electrode contain a positive electrode active material and a negative electrode active material, respectively. In order to obtain a high battery capacity, an Li composite oxide such as LiCoO₂ is used as the positive electrode active material, and a carbon material such as graphite is also used as the negative electrode active material.

In general, this secondary battery is used at an operating voltage of from 2.5 V to 4.2 V. The reason why even in a single cell, the operating voltage can be increased to 4.2 V resides in the fact that the positive electrode and the negative electrode are separated from each other via a separator, or a composition of the electrolytic solution is electrochemically stabilized.

Now, in aiming at even more enhancing the performance of the secondary battery and expanding the uses thereof, in order to more increase the battery capacity, it is investigated that the charge voltage is made higher than 4.2 V, thereby allowing the positive electrode active material to have a high energy density.

However, if the charge voltage is made higher than 4.2 V, the electrolytic solution is oxidized and decomposed in the vicinity of the surface of the positive electrode especially in a high-temperature environment, and therefore, a cycle characteristic that is an important characteristic of the secondary battery is easily lowered. In that case, a gas is produced within the battery due to a decomposition reaction of the electrolytic solution, and battery swelling and liquid leakage, and when occasion demands, battery explosion and the like are generated, and therefore, there is a possibility that the safety is lowered, too.

Then, in order to improve the cycle characteristic and the like, it is proposed to cover the surface of the positive electrode or the surface of the positive electrode active material by a metal oxide (see, for example, Japanese Patent No. 3172338 and JP-A-2000-195517). According to this, since a transition metal hardly elutes from the positive electrode into the electrolytic solution, the battery life is improved.

Also, in order to improve high-temperature characteristics and the like, it is proposed to add a phthalimide compound or a nitrile derivative or the like in an electrode (see, for example, JP-A-2002-270181 and JP-A-2005-072003). In the former case, since the phthalimide compound which has eluted into the electrolytic solution adsorbs on the surface of the positive electrode or negative electrode, the elution of a transition metal is suppressed in the positive electrode, and also the deposition of a transition metal is suppressed in the negative electrode. In the latter case, in order to suppress the battery swelling, a mixed solvent of a cyclic or chain ester and a lactone, or the like is used together with the nitrile derivative.

Furthermore, in order to improve a cycle characteristic, a storage characteristic, a swelling characteristic, and the like in the high-temperature environment, it is proposed to add an aromatic compound having nitrogen as a constituent element in the electrolytic solution (see, for example, US-A-2009/0035646, JP-A-2001-093571, JP-A-07-003101, and JP-A-05-029019). As this aromatic compound, bipyridine, triethylamine, or 1,8-bis(dimethylamino)naphthalene or a derivative thereof, etc. is used.

### SUMMARY

In order to improve the problems caused in the case of increasing the charge voltage for the purpose of increasing the battery capacity, there have been made various investigations. Nevertheless, it is difficult to say that sufficient countermeasures have been made. In particular, if an additive is added to the electrode and the electrolytic solution, etc. while taking safety into consideration, the additive reacts within the battery to form a resistor, so that in particular, the cycle characteristic is easily lowered in the high-temperature environment. Then, it is strongly demanded to attain a measure for enabling one to secure high-temperature characteristics of a secondary battery, namely a cycle characteristic even in the high-temperature environment.

It is therefore desirable to provide an electrolytic solution for secondary battery, a secondary battery, an electronic appliance, a power tool, an electric vehicle, and an electric power storage system, each of which is able to enhance high-temperature characteristics.

An electrolytic solution for secondary battery according to an embodiment of the present technology contains a nitrogen-containing compound, wherein the nitrogen-containing compound contains an aromatic skeleton containing one or two or more aromatic rings and one or two or more nitrogen-containing functional groups bonded to the one or two or more aromatic rings and represented by the following formula (1). Also, a secondary battery according to an embodiment of the present technology includes the foregoing electrolytic solution for secondary battery as well as a positive electrode and a negative electrode. Furthermore, an electronic appliance, a power tool, an electric vehicle, and an electric power storage system according to an embodiment of the present technology uses the foregoing secondary battery.

(YX═N— (1)

In the formula (1), X represents C or P; Y represents a group constituted of one kind or two or more kinds of elements selected from the group consisting of H, C, N, O, S, F, Cl, Br, and I, provided that arbitrary two or more of X and Y may be bonded to each other to form a ring structure; and z is 2 or 3.

Incidentally, the “aromatic skeleton” as referred to herein means a so-called aromatic compound. Also, it is meant by the terms “the nitrogen-containing functional group or groups are bonded to the aromatic skeleton” that the hydrogen group or groups in the aromatic skeleton that is an aromatic compound are substituted with the nitrogen-containing functional group or groups. Incidentally, examples of the aromatic skeleton having the number of aromatic rings of 1 include benzene, pyrrole, furan, thiophene, naphthalene, anthracene, phenanthrene, fluorene, and heterofluorene; and examples of the aromatic skeleton having the number of aromatic rings of 2 or more include biphenyl and terphenyl.

According to the electrolytic solution for secondary battery or the secondary battery according to the embodiments of the present technology, since the electrolytic solution contains the foregoing nitrogen-containing aromatic compound, a decomposition reaction of the electrolytic solution in the high-temperature environment is suppressed, and an increase of resistance in the inside of the battery is also suppressed. Thus, high-temperature characteristics can be enhanced. Also, in the electronic appliance, the power tool, the electric vehicle, and the electric power storage system according to the embodiment of the present technology, each of which uses the foregoing secondary battery, the same effects can be obtained.

### BRIEF DESCRIPTION OF THE DRAWINGS

FIG. 1 is a sectional view showing a configuration of a secondary battery (cylindrical type) of an embodiment of the present technology.

FIG. 2 is a sectional view showing enlargedly a part of a wound electrode body shown in FIG. 1.

FIG. 3 is a perspective view showing a configuration of another secondary battery (laminated film type) of an embodiment of the present technology.

FIG. 4 is a sectional view along a IV-IV line of a wound electrode body shown in FIG. 3.

FIG. 5 is a diagram expressing results of analysis of SnCoC by XPS.

### DETAILED DESCRIPTION

The present technology is hereunder described in detail by reference to the accompanying drawings. Incidentally, the description is made in the following order.

1. Secondary battery

1-1. Cylindrical type

1-2. Laminated film type

2. Use of secondary battery

### <1. Secondary Battery>

### <1-1. Cylindrical Type>

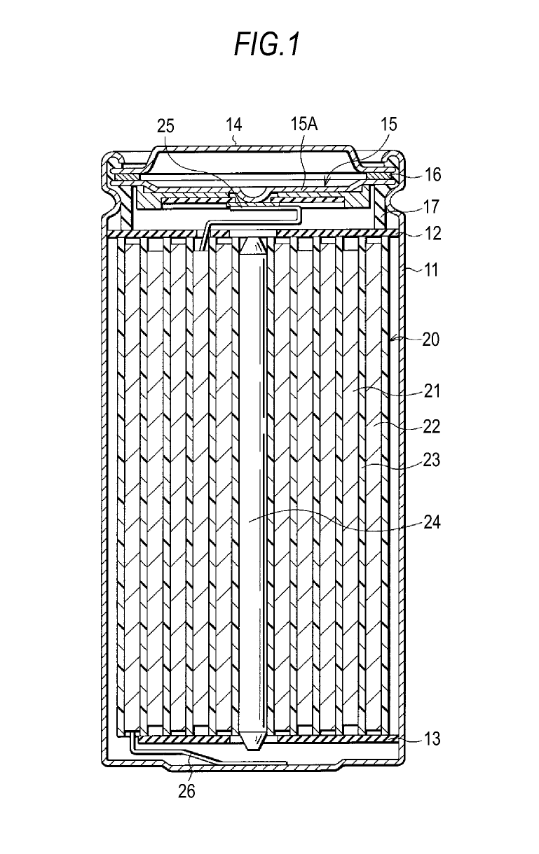

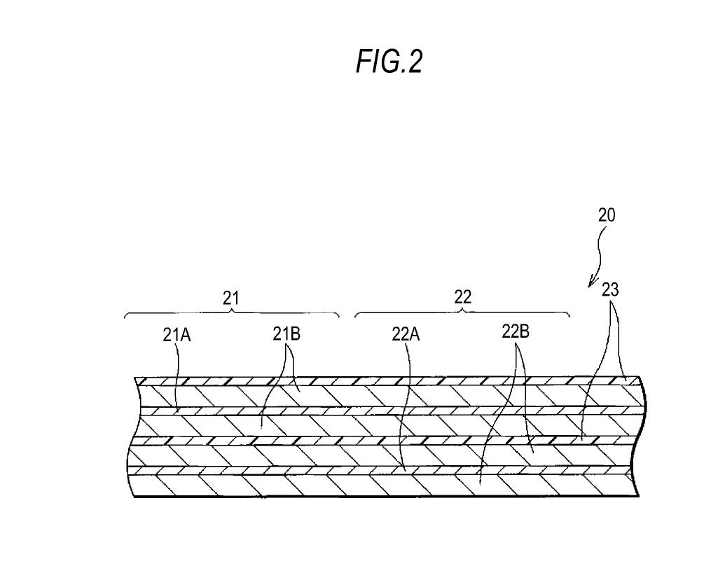

Each of FIGS. 1 and 2 shows a sectional configuration of a secondary battery in an embodiment of the present technology, in which FIG. 2 shows enlargedly a part of a wound electrode body 20 shown in FIG. 1.

### [Entire Configuration of Secondary Battery]

The secondary battery as described herein is, for example, a lithium ion secondary battery from which a battery capacity is obtained by intercalation and deintercalation of a lithium ion. This secondary battery is of a so-called cylindrical type, in which a wound electrode body 20 (including an electrolytic solution) and a pair of insulating plates 12 and 13 are housed in the inside of a substantially columnar battery can 11. In this wound electrode body 20, a positive electrode 21 and a negative electrode 22 are laminated and wound via a separator 23.

The battery can 11 has a hollow structure in which one end thereof is closed, with the other end being opened and is constituted of, for example, Fe, Al, or an alloy thereof. Incidentally, Ni or the like may be plated on the surface of the battery can 11. The pair of insulating plates 12 and 13 is respectively disposed such that they interpose the wound electrode body 20 vertically therebetween and extend perpendicular to the winding peripheral face thereof.

In the open end of the battery can 11, a battery lid 14, a safety valve mechanism 15, and a positive temperature coefficient device (PTC device) 16 are caulked via a gasket 17. According to this, the battery can 11 is hermetically sealed. The battery lid 14 is constituted of, for example, a material the same as that in the battery can 11. The safety valve mechanism 15 and the positive temperature coefficient device 16 are provided in the inside of the battery lid 14, and the safety valve mechanism 15 is electrically connected to the battery lid 14 via the positive temperature coefficient device 16. In this safety valve mechanism 15, when the inner pressure reaches a fixed value or more due to an internal short circuit or heating from the outside or the like, a disc plate 15A is reversed, whereby electrical connection between the battery lid 14 and the wound electrode body 20 is disconnected. The positive temperature coefficient device 16 prevents abnormal heat generation to be caused due to a large current. In this positive temperature coefficient device 16, the resistance increases in response to an increase of the temperature. The gasket 17 is constituted of, for example, an insulating material, and asphalt may be coated on the surface thereof.

A center pin 24 may be inserted on the center of the wound electrode body 20. A positive electrode lead 25 formed of an electrically conductive material, for example, Al, etc. is connected to the positive electrode 21; and a negative electrode lead 26 formed of an electrically conductive material, for example, Ni, etc. is also connected to the negative electrode 22. The positive electrode lead 25 is electrically connected to the battery lid 14 by means of welding with the safety valve mechanism 15, or the like; and the negative electrode lead 26 is also electrically connected to the battery can 11 by means of welding with the battery can 11, or the like.

### [Positive Electrode]

For example, the positive electrode 21 is one in which a positive electrode active material layer 21B is provided on one or both surfaces of a positive electrode collector 21A. The positive electrode collector 21A is formed of an electrically conductive material, for example, Al, Ni, stainless steel, etc.

The positive electrode active material layer 21B contains, as a positive electrode active material, one kind or two or more kinds of positive electrode materials capable of intercalating and deintercalating a lithium ion and may further contain other materials such as a positive electrode binder and a positive electrode electrically conductive agent, if desired.

The positive electrode material is preferably an Li-containing compound. This is because a high energy density is obtainable. Examples of this Li-containing compound include a complex oxide containing Li and a transition metal element as constituent elements and a phosphate compound containing Li and a transition metal element as constituent elements. Above all, the transition metal element is preferably any one kind or two or more kinds of Co, Ni, Mn, and Fe. This is because a higher voltage is obtainable. A chemical formula thereof is represented by, for example, LiₓMIO₂ or Li_{y}MIIPO₄. In the formulae, each of MI and MII represents one or more kinds of a transition metal element; and values of x and y vary depending upon the charge and discharge state and are usually satisfied with relationships of (0.05≦x≦1.10) and (0.05≦y≦1.10).

Examples of the complex oxide containing Li and a transition metal element include LiₓCoO₂, LiₓNiO₂, and an LiNi based complex oxide represented by the following formula (20). Also, examples of the phosphate compound containing Li and a transition metal element include LiFePO₄ and LiFe₁₋ᵤMnᵤPO₄ (u<1)). This is because a high capacity is obtainable, and an excellent cycle characteristic is also obtainable. Incidentally, the positive electrode material may be other materials than those described above.

LiNi₁₋ₓMₓO₂ (20)

In the formula (20), M represents at least one member selected from the group consisting of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb; and x is satisfied with a relationship of (0.005<x<0.5).

Besides, the positive electrode material may be, for example, an oxide, a disulfide, a chalcogenide, or an electrically conductive polymer. Examples of the oxide include titanium oxide, vanadium oxide, and manganese dioxide. Examples of the disulfide include titanium disulfide and molybdenum sulfide. Examples of the chalcogenide include niobium selenide. Examples of the electrically conductive polymer include a sulfur polymer, polyaniline, and polythiophene.

The positive electrode binder may contain any one kind or two or more kinds of, for example, synthetic rubbers or polymer materials. Examples of the synthetic rubber include a styrene butadiene based rubber, a fluorine based rubber, and an ethylene propylene diene based rubber. Examples of the polymer material include polyvinylidene fluoride and polyimide.

The positive electrode electrically conductive agent contains any one kind or two or more kinds of, for example, carbon materials. Examples of the carbon material include graphite, carbon black, acetylene black, and ketjen black. Incidentally, the positive electrode electrically conductive agent may be a metal material or an electrically conductive polymer so far as it is a material having electrical conductivity.

### [Negative Electrode]

For example, the negative electrode 22 is one in which a negative electrode active material layer 22B is provided on one or both surfaces of a negative electrode collector 22A.

The negative electrode collector 22A is formed of an electrically conductive metal material, for example, Cu, Ni, and stainless steel. It is preferable that the surface of this negative electrode collector 22A is roughed. This is because adhesion of the negative electrode active material layer 22B to the negative electrode collector 22A is enhanced due to a so-called anchor effect. In that case, the surface of the negative electrode collector 22A may be roughed in at least a region opposing to the negative electrode active material layer 22B. Examples of a method for achieving roughing include a method for forming fine particles by an electrolysis treatment. The electrolysis treatment as referred to herein is a method in which fine particles are formed on the surface of the negative electrode collector 22A in an electrolysis vessel by means of electrolysis, thereby providing recesses and projections. A copper foil which is fabricated by the electrolysis is generally named as “electrolytic copper foil”.

The negative electrode active material layer 22B contains, as a negative electrode active material, anyone kind or two or more kinds of a negative electrode material capable of intercalating and deintercalating a lithium ion and may contain other materials such as a negative electrode binder and a negative electrode electrically conductive agent, if desired. Incidentally, details regarding the negative electrode binder and the negative electrode electrically conductive agent are, for example, the same as those regarding the positive electrode binder and the positive electrode electrically conductive agent. In this negative electrode active material layer 22B, for example, for the purpose of preventing deposition of the Li metal without intention from occurring at the time of charge and discharge, it is preferable that the chargeable capacity of the negative electrode material is larger than the discharge capacity of the positive electrode 21.

The negative electrode material is, for example, a carbon material. This is because a change in a crystal structure at the time of intercalation and deintercalation of a lithium ion is very small, and therefore, a high energy density and an excellent cycle characteristic are obtainable, and the carbon material also functions as a negative electrode electrically conductive agent. Examples of this carbon material include easily graphitized carbon, hardly graphitized carbon with a (002) plane interval of 0.37 nm or more, and graphite with a (002) plane interval of not more than 0.34 nm. More specifically, there are exemplified pyrolytic carbons, cokes, vitreous carbon fibers, organic polymer compound baked materials, active carbon, and carbon blacks. Of these, examples of the cokes include pitch coke, needle coke, and petroleum coke. The organic polymer compound baked material is a material obtained by baking (carbonizing) a polymer compound such as a phenol resin and a furan resin at an appropriate temperature. Besides, the carbon material may be lowly crystalline carbon or amorphous carbon having been heat treated at not higher than about 1,000° C. Incidentally, the shape of the carbon material may be any of a fibrous shape, a spherical shape, a granular shape, or a flaky shape.

Also, the negative electrode material is, for example, a material (metal based material) containing any one kind or two kinds of metal elements or semi-metal elements. This is because a high energy density is obtainable. Such a metal based material may be a simple substance, an alloy, or a compound of a metal element or a semi-metal element, or it may be two or more kinds thereof. Also, it may be one having one kind or two or more kinds of a phase in at least apart thereof. The alloy includes, in addition to materials composed of two or more kinds of a metal element, materials containing one or more kinds of a metal element and one or more kinds of a semi-metal element. Also, the alloy may contain a non-metal element. Examples of its texture include a solid solution, a eutectic (eutectic mixture), an intermetallic compound, and one in which two or more kinds thereof coexist.

Examples of the metal element or semi-metal element include a metal element or a semi-metal element capable of forming an alloy together with Li. Specifically, the metal element or semi-metal element is one kind or two or more kinds of the following elements. That is, examples thereof include Mg, B, Al, Ga, In, Si, Ge, Sn, Pb, Bi, Cd, Ag, Zn, Hf, Zr, Y, Pd, and Pt. Above all, at least one of Si and Sn is preferable. This is because Si and Sn have excellent ability to intercalate and deintercalate a lithium ion, and therefore, a high energy density is obtainable.

The material containing at least one of Si and Sn may be a simple substance, an alloy, or a compound of Si or Sn, or it may be two or more kinds thereof. Also, the material may be one having one kind or two or more kinds of a phase in at least a part thereof. Incidentally, the “simple substance” as referred to herein is a simple substance in a general meaning to the bitter end (may contain a trace amount of impurities), and it is not always meant that the purity is 100%.

The alloy of Si is a material containing, for example, one kind or two or more kinds of the following elements as a constituent element other than Si. That is, examples thereof include Sn, Ni, Cu, Fe, Co, Mn, Zn, In, Ag, Ti, Ge, Bi, Sb, and Cr. Examples of the compound of Si include materials containing O or C as a constituent element other than Si. Incidentally, the compound of Si may contain, for example, any one kind or two or more kinds of the elements described above regarding the alloy of Si as a constituent element other than Si.

Examples of the alloy or compound of Si include the following materials. That is, examples thereof include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, and TaSi₂. Also, examples thereof include VSi₂, WSi₂, ZnSi₂, SiC, Si₃N₄, Si₂N₂O, SiOᵥ (0<v≦2), and LiSiO. Incidentally, v in SiOᵥ may be satisfied with a relationship of (0.2<v<1.4).

The alloy of Sn is a material containing, for example, one kind or two or more kinds of the following elements as a constituent element other than Sn. That is, examples thereof include Si, Ni, Cu, Fe, Co, Mn, Zn, In, Ag, Ti, Ge, Bi, Sb, and Cr. Examples of the compound of Sn include materials containing O or C as a constituent element. Incidentally, the compound of Sn may contain, for example, any one kind or two or more kinds of the elements described above regarding the alloy of Sn as a constituent element other than Sn. Examples of the alloy or compound of Sn include SnO_{w} (0<w≦2), SnSiO₃, LiSnO, and Mg₂Sn.

Also, as the material containing Sn, for example, a material containing Sn as a first constituent element and in addition to this, second and third constituent elements is preferable. The second constituent element is, for example, one kind or two or more kinds of the following elements. That is, examples thereof include Co, Fe, Mg, Ti, V, Cr, Mn, Ni, Cu, Zn, Ga, Zr, Nb, Mo, Ag, In, Ce, Hf, Ta, W, Bi, and Si. The third constituent element is, for example, one kind or two or more kinds of B, C, Al, and P. This is because when the second and third constituent elements are contained, a high battery capacity and an excellent cycle characteristic are obtainable.

Above of all, a material containing Sn, Co, and C (SnCoC-containing material) is preferable. For example, the SnCoC-containing material has a composition having a content of C of from 9.9% by mass to 29.7% by mass and a proportion of contents of Sn and Co (Co/(Sn+Co)) of from 20% by mass to 70% by mass. This is because a high energy density is obtainable in the foregoing composition range.

Such an SnCoC-containing material has a phase containing Sn, Co, and C, and this phase is preferably lowly crystalline or amorphous. This phase is a reaction phase which is reactive with Li, and an excellent cycle characteristic is obtainable by the reaction phase. In the case of using CuKα-rays as specified X-rays and defining a sweep rate at 1°/min, a half width of a diffraction peak obtained by X-ray diffraction of this phase is preferably 1.0° or more in terms of a diffraction angle 2θ. This is because a lithium ion is more smoothly intercalated and deintercalated, and the reactivity with an electrolytic solution is also reduced. Incidentally, there may be the case where the SnCoC-containing material contains, in addition to the lowly crystalline or amorphous phase, a phase containing a simple substance or a part of each of the constituent elements.

Whether or not the diffraction peak obtained by the X-ray diffraction is corresponding to the reaction phase which is reactive with Li can be easily determined by comparing an X-ray diffraction chart before and after an electrochemical reaction with Li. For example, when a position of the diffraction peak changes before and after the electrochemical reaction with Li, it is determined that the diffraction peak is corresponding to the reaction phase which is reactive with Li. In that case, for example, a diffraction peak of a lowly crystalline or amorphous reaction phase is observed in the range of from 20° to 50° in terms of 2θ. Such a reaction phase contains, for example, the foregoing respective constituent elements, and it may be considered that this phase is lowly crystallized or amorphized chiefly due to the presence of C.

In the SnCoC-containing material, it is preferable that at least a part of C that is the constituent element is bonded to the metal element or semi-metal element that is other constituent element. This is because aggregation or crystallization of Sn or the like is suppressed. The bonding state of elements can be confirmed by, for example, X-ray photoelectron spectroscopy (XPS). In commercially available apparatuses, for example, Al—Kα rays or Mg—Kα rays are used as soft X-rays. In the case where at least a part of C is bonded to the metal element or semi-metal element or the like, a peak of a combined wave of a is orbit of C (C1s) appears in a region lower than 284.5 eV. Incidentally, the energy is considered to be calibrated such that a peak of a 4f orbit of an Au atom (Au4f) is obtained at 84.0 eV. On the occasion, in general, since surface contamination carbon exists on the surface of a material, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of C in the SnCoC-containing material, the peaks of the both are separated from each other by means of analysis using, for example, a commercially available software program. In the analysis of the waveform, the position of a main peak existing on the side of a lowest binding energy is used as an energy reference (284.8 eV).

Incidentally, the SnCoC-containing material may further contain other constituent element, if desired. Examples of such other constituent element include Si, Fe, Ni, Cr, In, and N.

In addition to this SnCoC-containing material, a material containing Sn, Co, Fe, and C (SnCoFeC-containing material) is also preferable. A composition of this SnCoFeC-containing material can be arbitrarily set up. For example, in the case where a content of Fe is set up low, its composition is one in which a content of C is from 9.9% by mass to 29.7% by mass, a content of Fe is from 0.3% by mass to 5.9% by mass, and a proportion of contents of Sn and Co (Co/(Sn+Co)) is from 30% by mass to 70% by mass. Also, for example, in the case where a content of Fe is set up high, its composition is one in which a content of C is from 11.9% by mass to 29.7% by mass, a proportion of contents of Sn, Co, and Fe ((Co+Fe)/(Sn+Co+Fe)) is from 26.4% by mass to 48.5% by mass, and a proportion of contents of Co and Fe (Co/(Co+Fe)) is from 9.9% by mass to 79.5% by mass. This is because a high energy density is obtainable in the foregoing composition range. Physical properties (for example, a half width, etc.) of this SnCoFeC-containing material are the same as those in the foregoing SnCoC-containing material.

Also, other negative electrode material may be, for example, a metal oxide or a polymer compound. Examples of the metal oxide include iron oxide, ruthenium oxide, and molybdenum oxide. Examples of the polymer compound include polyacetylene, polyaniline, and polypyrrole.

The negative electrode active material layer 22B may be, for example, formed by a coating method, a vapor phase method, a liquid phase method, a spraying method, or a baking method (sintering method), or a combined method of two or more kinds of these methods. The coating method as referred to herein is, for example, a method in which after mixing a granular negative electrode active material with a binder and the like, the mixture is dispersed in a solvent such as an organic solvent and coated. Examples of the vapor phase method include a physical deposition method and a chemical deposition method. Specific examples thereof include a vacuum vapor deposition method, a sputtering method, an ion plating method, a laser abrasion method, a thermal chemical vapor deposition method, a chemical vapor deposition (CVD) method, and a plasma chemical vapor deposition method. Examples of the liquid phase method include an electrolytic plating method and a non-electrolytic plating method. The spraying method as referred to herein is a method of spraying a negative electrode active material in a molten state or a semi-molten state. The baking method as referred to herein is, for example, a method in which after coating in the same procedure as that in the coating method, the coated material is heat treated at a higher temperature than a melting point of the binder or the like. As to the baking method, known techniques can be adopted. Examples thereof include an atmospheric baking method, a reaction baking method, and a hot press baking method.

### [Separator]

The separator 23 is a porous film which partitions the positive electrode 21 and the negative electrode 22 from each other and allows a lithium ion to pass therethrough while preventing a short circuit of the current to be caused due to the contact between the both electrodes from occurring. This separator 23 is impregnated with a liquid electrolyte (electrolytic solution).

This separator 23 contains, for example, a polymer compound such as polyethylene, polypropylene, polyvinylidene fluoride, polytetrafluoroethylene, aramid, polyamide-imide, polyamide, polyimide, polyether imide, and polyacrylonitrile.

Incidentally, the separator 23 may contain an inorganic fine particle, if desired. This inorganic fine particle is, for example, an oxide such as Al₂O₃, SiO₂, MgO, TiO₂, and ZrO₂. Such an inorganic fine particle may be used alone or in admixture of two or more kinds thereof.

In particular, the separator 23 may be formed of one kind of a polymer compound, or may be formed of two or more kinds of polymer compounds. The separator 23 formed of one kind of a polymer compound is, for example, a single-layer film made of a porous film of polyethylene or the like.

On the other hand, the separator 23 formed of two or more kinds of polymer compounds may, for example, have a multi-layer structure (laminated type) composed of a laminate of two or more kinds of polymer compounds in the thickness direction. Alternatively, the separator 23 may, for example, have a single-layer structure (mixed type) composed of two or more kinds of polymer compounds having a different composition from each other in the thickness direction. The separator 23 of a laminated type is, for example, one in which two or more kinds of polymer compound films (for example, polymer films) are laminated in the thickness direction, and examples thereof include a laminate of polypropylene film/polyethylene film/polypropylene film. The separator 23 of a mixed type is, for example, a composite film in which the composition of the polymer compound changes in the thickness direction in such a manner of polypropylene/polyethylene/polypropylene. In that case, the component amount of the polymer compound of the above-specified kind becomes rich at each stage.

### [Electrolytic Solution]

This separator 23 is impregnated with an electrolytic solution that is a liquid electrolyte. This electrolytic solution contains a nitrogen-containing aromatic compound together with a solvent and an electrolyte salt, and it may contain other materials such as various additives, if desired.

### [Nitrogen-Containing Aromatic Compound]

This nitrogen-containing aromatic compound contains an aromatic skeleton containing one or two or more aromatic rings and one or two or more nitrogen-containing functional groups bonded to the one or two or more aromatic rings and represented by the following formula (1).

(YX═N— (1)

In the formula (1), X represents C or P; Y represents a group constituted of one kind or two or more kinds of elements selected from the group consisting of H, C, N, O, S, F, Cl, Br, and I, provided that arbitrary two or more of X and Y may be bonded to each other to form a ring structure; and z is 2 or 3.

The reason why the electrolytic solution contains the nitrogen-containing aromatic compound resides in the matter that a decomposition reaction of the electrolytic solution is suppressed in the high-temperature environment as compared with the case where the nitrogen-containing aromatic compound is not contained. Also, this is because a free Arrhenius acid produced in the vicinity of each of the positive electrode 21 and the negative electrode 22 at the time of charge and discharge rapidly reduces, so that an increase of the resistance in the inside of the battery is also suppressed.

Details regarding the chemical structure of this nitrogen-containing aromatic compound are as follows.

First of all, the nitrogen-containing aromatic compound contains an aromatic skeleton as a basic skeleton, and the aromatic skeleton contains one or two or more aromatic rings. So far as this aromatic skeleton contains one or two or more aromatic rings, it may be a single ring such as benzene and pyrrole, or may be a condensed ring of two or more benzene rings or the like or a non-condensed ring in which two benzene rings or the like are bonded to each other via a single bond. As a matter of course, the aromatic skeleton may contain a mixture of two or more kinds of the foregoing series of rings.

Examples of the aromatic skeleton having the number of aromatic rings of 1 include benzene, pyrrole, furan, thiophene, naphthalene, anthracene, phenanthrene, fluorene, and heterofluorene. Examples of the aromatic skeleton having the number of aromatic rings of 2 or more include biphenyl and terphenyl. The heterofluorene as referred to herein is a compound in which C interposed between the two benzene rings of fluorene is substituted with O, S, Se, Te, etc. As a matter of course, the kind of the aromatic skeleton may be other compound than those described above so far as it is an aromatic compound. Above all, the aromatic skeleton is preferably naphthalene, biphenyl, phenanthrene, fluorene, or heterofluorene. This is because higher effects are obtainable.

Secondly, in the nitrogen-containing aromatic compound, a nitrogen-containing functional group is bonded to the aromatic ring, namely the hydrogen group in the aromatic ring is substituted with a nitrogen-containing functional group.

Y constituting the nitrogen-containing functional group is a group constituted of one kind or two or more kinds of elements selected from the group consisting of H, C, N, O, S, F, Cl, Br, and I. For that reason, Y may be a group constituted of one kind of an element, such as —H, —F, —Cl, and —Br, or may be a group constituted of two or more kinds of elements, such as —NH₂. Besides, Y that is a group constituted of two or more kinds of elements may be, for example, a halogenated hydrocarbon group, —CN, or the like, or may be a hydrocarbon group, a halogenated hydrocarbon group, or the like having one or two or more of —O—, >C═O, —C(═O)O—, etc. on the way. Examples of the hydrocarbon group include an alkyl group, an alkenyl group, an alkynyl group, a cyclohexyl group, and an aryl group. Examples of the halogenated hydrocarbon group include groups obtained by substituting at least one hydrogen group of the foregoing alkyl group or the like with a halogen group, and examples of the halogen group include a fluorine group, a chlorine group, and a bromine group. The number (z) of Y is determined depending upon the kind of X. That is, in the case where X is C, z is 2, and in the case where X is P, z is 3. Each Y may be a group the same as or different from every other Y. Incidentally, X and Y may be bonded to each other to form a ring, or each Y may be bonded to every other Y to form a ring.

So far as the aromatic skeleton contains one or two or more aromatic rings, it may contain a connecting group, etc. together with the aromatic ring or rings; however, the nitrogen-containing functional group or groups are always bonded to the aromatic ring or rings. Examples of this connecting group include an alkylene group, an alkenylene group, and an alkynylene group, each of which is inserted between the two aromatic rings.

Y may be either an electron donating group or an electron withdrawing group, and above all, Y is preferably an electron donating group. This is because higher effects are obtainable. The electron donating group as referred to herein is, for example, a group which contains, as a constituent element, one kind or two or more kinds of elements selected from the group consisting of H, C, N, O, S, F, Cl, Br, and I, and which includes a hydrocarbon group having an arbitrary carbon number, such as an alkyl group, an alkylene group, an alkenyl group, an alkynyl group, and an aryl group, an amino group (—NH₂), a monoalkylamino group (—NHR), a dialkylamino group (—NR₂), a mercapto group (—SH), and a sulfide group (—SR). Also, the electron donating group may be a group (composite functional group) obtained by combining two or more kinds of the foregoing series of groups, such as a hydrocarbon group having an amino group, etc. in a molecule thereof. Besides, the electron donating group may also be a hydrocarbon group having a halogen group such as a fluorine group (—F), a chlorine group (—Cl), a bromine group (—Br), and an iodine group (—I), an acyl group (—OCR), an alkoxy group (—OR), etc. in a molecule thereof. In the foregoing, R is an alkyl group, and a carbon number thereof is arbitrary. Above all, Y that is an electron donating group is preferably at least one of a dialkylamino group and an aryl group. Incidentally, the electron withdrawing group is, for example, a halogenated hydrocarbon group such as a trifluoromethyl group (—CF₃).

Though the number of nitrogen-containing functional groups is not particularly limited, it is especially preferably 2 or more. This is because higher effects are obtainable.

The position of the nitrogen-containing functional group to be bonded to the aromatic ring is not particularly limited. Specifically, the case where the number of aromatic rings is 1 (the aromatic skeleton is naphthalene), and the number of nitrogen-containing functional groups is 2 is taken as an example. In that case, in the two rings constituting naphthalene (here, the benzene rings), the two nitrogen-containing functional groups may be bonded to only one ring, the nitrogen-containing functional groups may be bonded to only the other ring, or everyone nitrogen-containing function group may be bonded to every ring. For example, in the case where the aromatic skeleton is a condensed ring such as naphthalene, the “ring” as referred to herein means each of the two benzene rings constituting naphthalene as described above. Also, in the case where the aromatic skeleton is a non-condensed ring such as biphenyl, the “ring” means each of the two benzene rings connected to each other via a single bond.

Above all, in the case where not only the aromatic ring contains two or more rings, but the number of nitrogen-containing functional groups is 2 or more, it is preferable that the nitrogen-containing functional group is bonded to every ring of at least two rings of the two or more rings. That is, in the case where the number of nitrogen-containing functional groups is 2 or more, it is preferable that at least two nitrogen-containing functional groups thereof are present separately in a ring different from each other. Specifically, the case where the number of rings (here, the benzene ring) is 2 (the aromatic skeleton is naphthalene) is taken as an example. In the case where the number of nitrogen-containing functional groups is 2, it is preferable that the first nitrogen-containing functional group is bonded to one of the rings, whereas the second nitrogen-containing functional group is bonded to the other ring. Also, the case where the number of rings is 3 (the aromatic skeleton is phenanthrene) is taken as an example. In the case where the number of nitrogen-containing functional groups is 2, it is preferable that the first nitrogen-containing functional group is bonded to one of the three rings, whereas the second nitrogen-containing functional group is bonded to one of the remaining two rings (whichever ring). Incidentally, in the case where the number of rings is 2, in the case where the number of nitrogen-containing functional groups is 3, the third nitrogen-containing functional group may be bonded to any ring of the two rings.

Incidentally, a positional relation of the two or more nitrogen-containing functional groups is not particularly limited. Above all, it is preferable that a distance between the two nitrogen-containing functional groups existing in a different ring from each other is small as far as possible. More specifically, for example, a value counted from a carbon atom in the ring to which one of the nitrogen-containing functional groups is bonded to a carbon atom in other ring to which the other nitrogen-containing function group is bonded such that the number of carbon atoms becomes the smallest is preferably from 2 to 4. This is because higher effects are obtainable as compared with the case where the number of carbon atoms is larger than 4.

Thirdly, the nitrogen-containing aromatic compound may contain one or two or more substituents together with the foregoing aromatic skeleton and nitrogen-containing group or groups. In that case, the hydrogen group or groups in one or two or more aromatic rings are substituted with a substituent. In the nitrogen-containing aromatic compound, the substituent may be contained in any aromatic ring of the one or two or more aromatic rings. Here, the case where the number of rings in the aromatic ring is 2 (the aromatic skeleton is naphthalene) is taken as an example. In the case where the number of substituents is 2, the two substituents may be contained in the same ring, or every one substituent may be contained in a ring different from each other.

This substituent is, for example, a group constituted of one kind or two or more kinds of elements selected from the group consisting of H, C, N, O, S, F, Cl, Br, and I. In the case where the number of substituents is 2 or more, each substituent may be a group the same as or different from every other substituent. Also, arbitrary two or more substituents may be bonded to each other to form a ring. Though the kind of the substituent is not particularly limited, for example, it is the same group as that described above for Y.

This nitrogen-containing aromatic compound contains, for example, at least one of compounds represented by the following formulae (2) to (5). This is because it can be easily synthesized, and excellent effects are also obtainable.

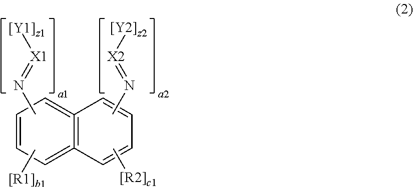

In the formula (2), each of X1 and X2 represents C or P; each of Y1, Y2, R1, and R2 represents a group constituted of one kind or two or more kinds of elements selected from the group consisting of H, C, N, O, S, F, Cl, Br, and I, provided that arbitrary two or more of X1, X2, Y1, Y2, R1, and R2 may be bonded to each other to form a ring structure; each of z1 and z2 is 2 or 3; and each of a1, a2, b1, and c1 represents an integer and is satisfied with relationships of a1≧0, a2≧0, b1≧0, and c1≧0, respectively, provided that (a1+a2)≧1.

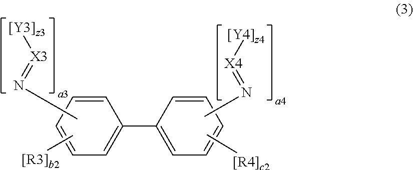

In the formula (3), each of X3 and X4 represents C or P; each of Y3, Y4, R3, and R4 represents a group constituted of one kind or two or more kinds of elements selected from the group consisting of H, C, N, O, S, F, Cl, Br, and I, provided that arbitrary two or more of X3, X4, Y3, Y4, R3, and R4 may be bonded to each other to form a ring structure; each of z3 and z4 is 2 or 3; and each of a3, a4, b2, and c2 represents an integer and is satisfied with relationships of a3≧0, a4≧0, b2≧0, and c2≧0, respectively, provided that (a3+a4)≧1.

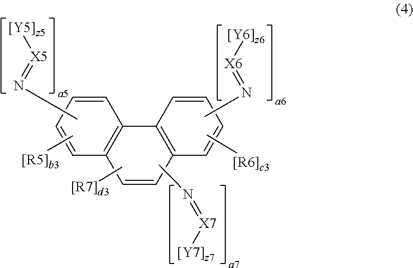

In the formula (4), each of X5 to X7 represents C or P; each of Y5 to Y7 and R5 to R7 represents a group constituted of one kind or two or more kinds of elements selected from the group consisting of H, C, N, O, S, F, Cl, Br, and I, provided that arbitrary two or more of X5 to X7, Y5 to Y7, and R5 to R7 may be bonded to each other to form a ring structure; each of z5 to z7 is 2 or 3; and each of a5 to a7, b3, c3, and d3 represents an integer and is satisfied with relationships of a5≧0, a6≧0, a7≧0, b3≧0, c3≧0, and d3≧0, respectively, provided that (a5+a6+a7)≧1.

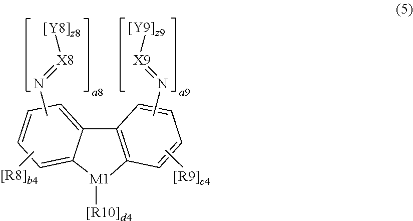

In the formula (5), each of X8 and X9 represents C or P; each of Y8, Y9, and R8 to R10 represents a group constituted of one kind or two or more kinds of elements selected from the group consisting of H, C, N, O, S, F, Cl, Br, and I, provided that arbitrary two or more of X8, X9, Y8, Y9, and R8 to R10 may be bonded to each other to form a ring structure; M1 represents C, O, S, Se, or Te; each of z8 and z9 is 2 or 3; and each of a8, a9, b4, c4, and d4 represents an integer and is satisfied with relationships of a8≧0, a9≧0, b4≧0, c≧0, and d4≧0, respectively, provided that (a8+a9)≦1.

The basic skeleton of the nitrogen-containing aromatic compound is naphthalene in the formula (2), biphenyl in the formula (3), phenanthrene in the formula (4), and fluorene (M1=C) or heterofluorene (M1=O, S, Se, or Te) in the formula (5), respectively.

Incidentally, details regarding X1 to X9, Y1 to Y9, and z1 to z9 are synonymous with those in X, Y, and z in the formula (1), respectively. In the formula (2), the numbers of nitrogen-containing functional groups (a1 and a2) are satisfied with relationships of a1≧0 and a2≧0 and also satisfied with a relationship of (a1+a2)≧1. That is, the nitrogen-containing aromatic compound always has one or more nitrogen-containing functional groups. This is also the same as to a3 to a9 in the formulae (3) to (5).

Each of R1 to R9 shown in the formulae (2) to (5) is the foregoing substituent. Incidentally, in the formula (2), the numbers of substituents (b1 and c1) are satisfied with relationships of b1≧0 and c1≧0. That is, the substituent may be present or absent. This is also the same as to b2 to b4, c2 to c4, d3, and d4 in the formulae (3) to (5).

Above all, the nitrogen-containing aromatic compounds represented by the formulae (2) to (5) are preferably at least one of compounds represented by the following formulae (6) to (13). This is because higher effects are obtainable.

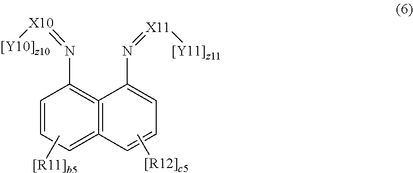

In the formula (6), each of X10 and X11 represents C or P; each of Y10, Y11, R11, and R12 represents a group constituted of one kind or two or more kinds of elements selected from the group consisting of H, C, N, O, S, F, Cl, Br, and I, provided that arbitrary two or more of X10, X11, Y10, Y11, R11, and R12 may be bonded to each other to form a ring structure; each of z10 and z11 is 2 or 3; and each of b5 and c5 represents an integer and is satisfied with relationships of b5≧0 and c5≧0.

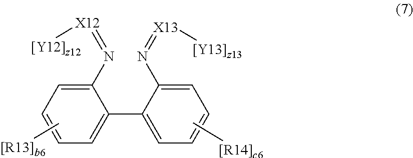

In the formula (7), each of X12 and X13 represents C or P; each of Y12, Y13, R13, and R14 represents a group constituted of one kind or two or more kinds of elements selected from the group consisting of H, C, N, O, S, F, Cl, Br, and I, provided that arbitrary two or more of X12, X13, Y12, Y13, R13, and R14 may be bonded to each other to form a ring structure; each of z12 and z13 is 2 or 3; and each of b6 and c6 represents an integer and is satisfied with relationships of b6≧0 and c6≧0.

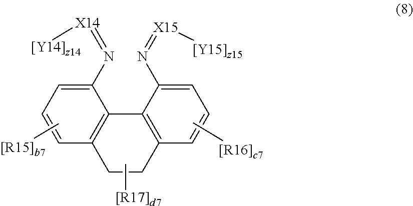

In the formula (8), each of X14 and X15 represents C or P; each of Y14, Y15, and R15 to R17 represents a group constituted of one kind or two or more kinds of elements selected from the group consisting of H, C, N, O, S, F, Cl, Br, and I, provided that arbitrary two or more of X14, X15, Y14, Y15, and R15 to R17 may be bonded to each other to form a ring structure; each of z14 and z15 is 2 or 3; and each of b7, c7, and d7 represents an integer and is satisfied with relationships of b7≧0, c7≧0, and d7≧0.

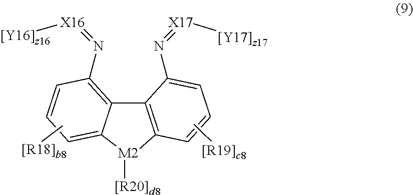

In the formula (9), each of X16 and X17 represents C or P; each of Y16, Y17, and R18 to R20 represents a group constituted of one kind or two or more kinds of elements selected from the group consisting of H, C, N, O, S, F, Cl, Br, and I, provided that arbitrary two or more of X16, X17, Y16, Y17, and R18 to R20 may be bonded to each other to form a ring structure; M2 represents C, O, S, Se, or Te; each of z16 and z17 is 2 or 3; and each of b8, c8, and d8 represents an integer and is satisfied with relationships of b8≧0, c8≧0, and d8≧0.

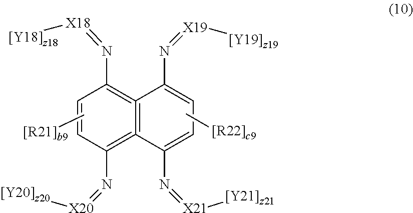

In the formula (10), each of X18 to X21 represents C or P; each of Y18 to Y21, R21, and R22 represents a group constituted of one kind or two or more kinds of elements selected from the group consisting of H, C, N, O, S, F, Cl, Br, and I, provided that arbitrary two or more of X18 to X21, Y18 to Y21, R21, and R22 may be bonded to each other to form a ring structure; each of z18 to z21 is 2 or 3; and each of b9 and c9 represents an integer and is satisfied with relationships of b9≧0 and c9≧0.

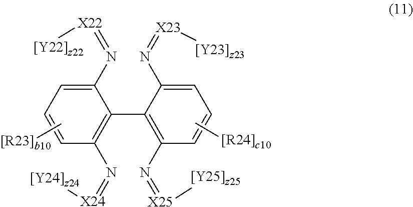

In the formula (11), each of X22 to X25 represents C or P; each of Y22 to Y25, R23, and R24 represents a group constituted of one kind or two or more kinds of elements selected from the group consisting of H, C, N, O, S, F, Cl, Br, and I, provided that arbitrary two or more of X22 to X25, Y22 to Y25, R23, and R24 may be bonded to each other to form a ring structure; each of z22 to z25 is 2 or 3; and each of b10 and c10 represents an integer and is satisfied with relationships of b10≧0 and c10≧0.

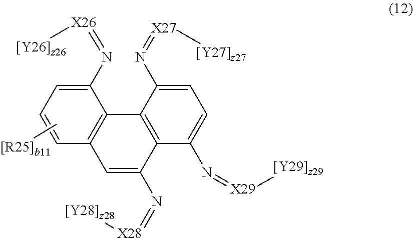

In the formula (12), each of X26 to X29 represents C or P; each of Y26 to Y29 and R25 represents a group constituted of one kind or two or more kinds of elements selected from the group consisting of H, C, N, O, S, F, Cl, Br, and I, provided that arbitrary two or more of X26 to X29, Y26 to Y29, and R25 may be bonded to each other to form a ring structure; each of z26 to z29 is 2 or 3; and b11 represents an integer and is satisfied with relationships of b11≧0.

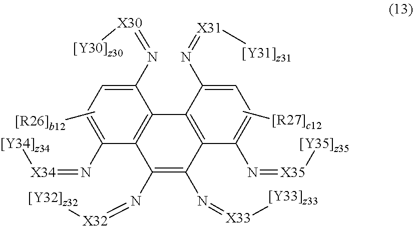

In the formula (13), each of X30 to X35 represents C or P; each of Y30 to Y35, R26, and R27 represents a group constituted of one kind or two or more kinds of elements selected from the group consisting of H, C, N, O, S, F, Cl, Br, and I, provided that arbitrary two or more of X30 to X35, Y30 to Y35, R26, and R27 may be bonded to each other to form a ring structure; each of z30 to z35 is 2 or 3; and each of b12 and c12 represents an integer and is satisfied with relationships of b12≧0 and c12≧0.

The nitrogen-containing aromatic compounds represented by the formulae (6) and (10) are corresponding to the formula (2). The nitrogen-containing aromatic compounds represented by the formulae (7) and (11) are corresponding to the formula (3). The nitrogen-containing aromatic compounds represented by the formulae (8), (12) and (13) are corresponding to the formula (4). The nitrogen-containing aromatic compound represented by the formula (9) is corresponding to the formula (5).

Incidentally, details regarding X10 to X35, Y10 to Y35, and z10 to z35 are synonymous with those in X, Y, and z in the formula (1), respectively. Each of R11 to R27 shown in the formulae (6) to (13) is the foregoing substituent. In the formula (6), the numbers of substituents (b5 and c5) are satisfied with relationships of b5≧0 and c5≧0. That is, the substituent may be present or absent. This is also the same as to b6 to b12, c6 to c12, d7, and d8 in the formulae (7) to (13).

More specifically, specific examples of the nitrogen-containing aromatic compound are at least one of compounds represented by the following formulae (14-1) to (14-33). The aromatic skeleton of this nitrogen-containing aromatic compound is benzene.

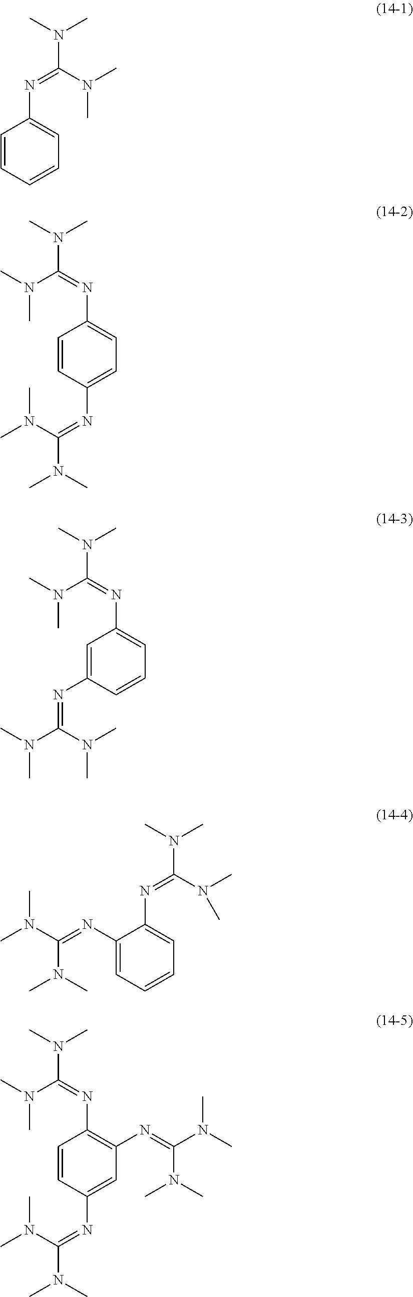

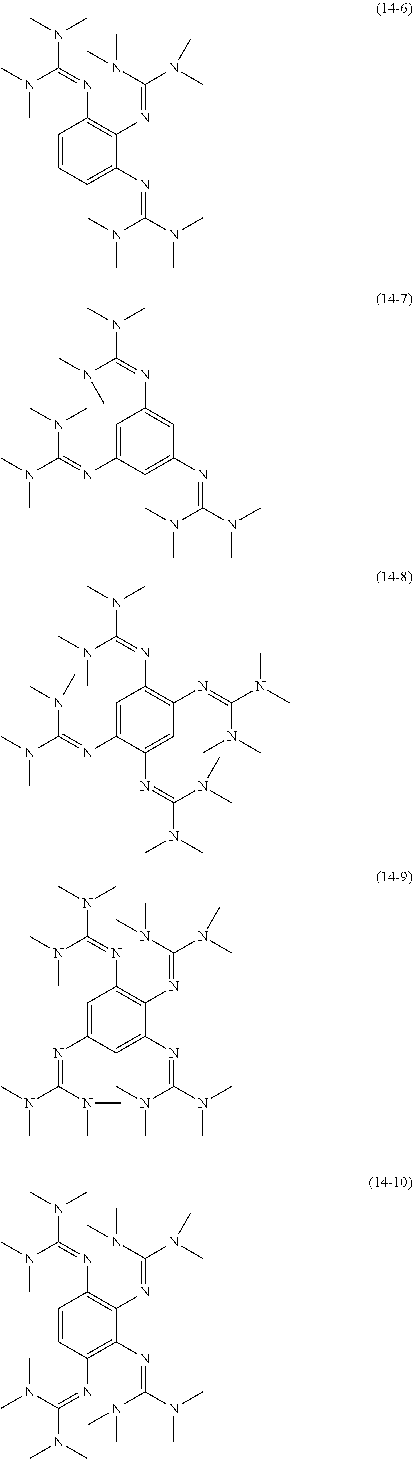

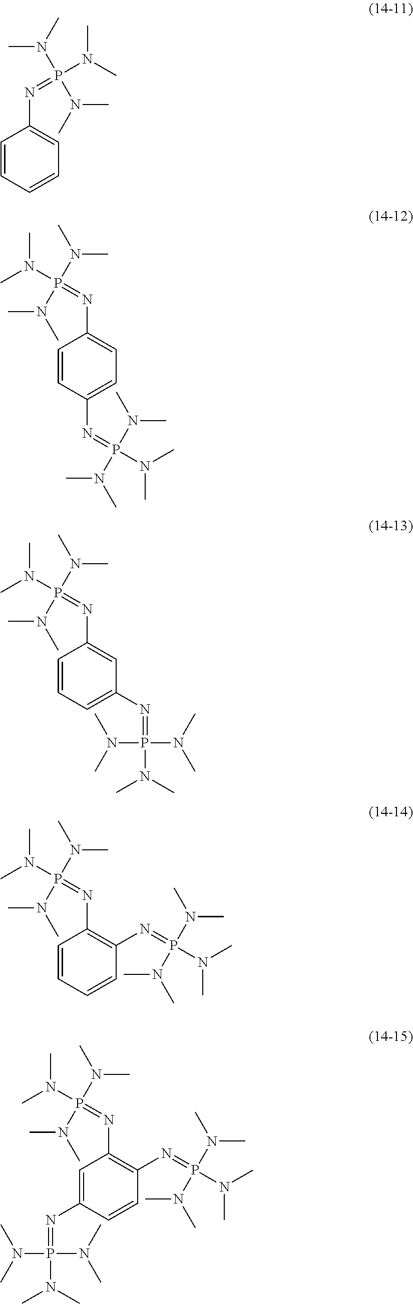

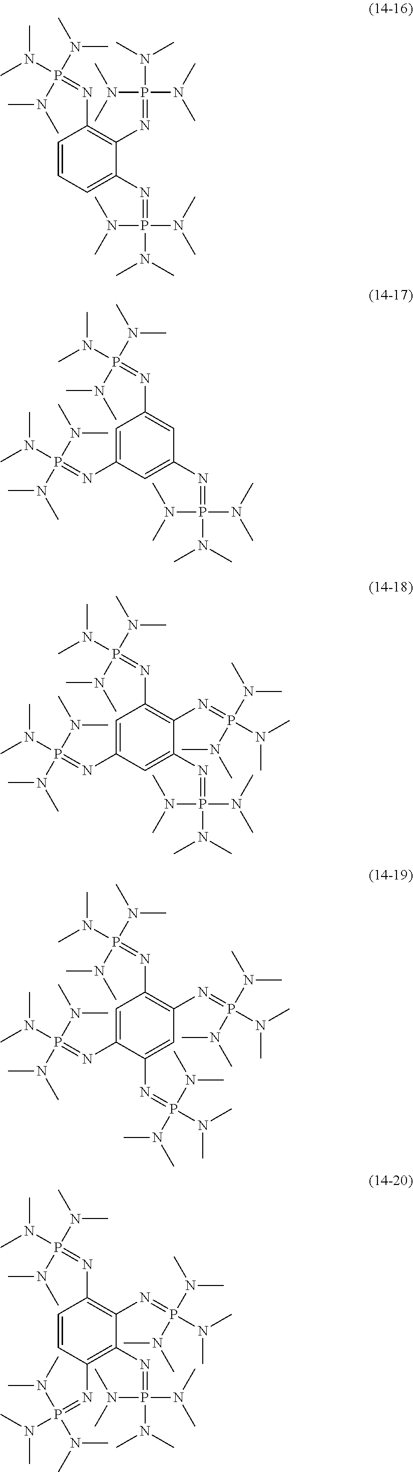

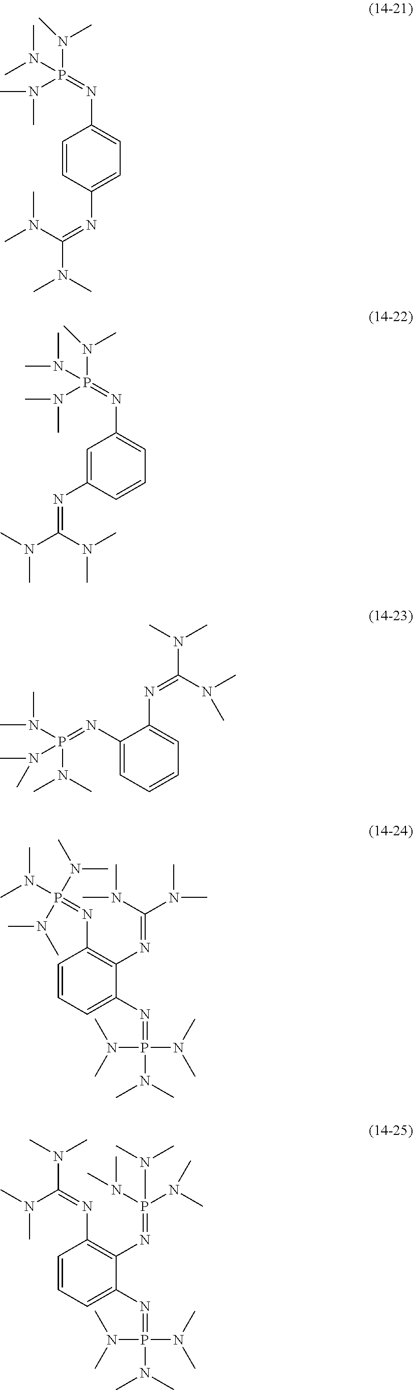

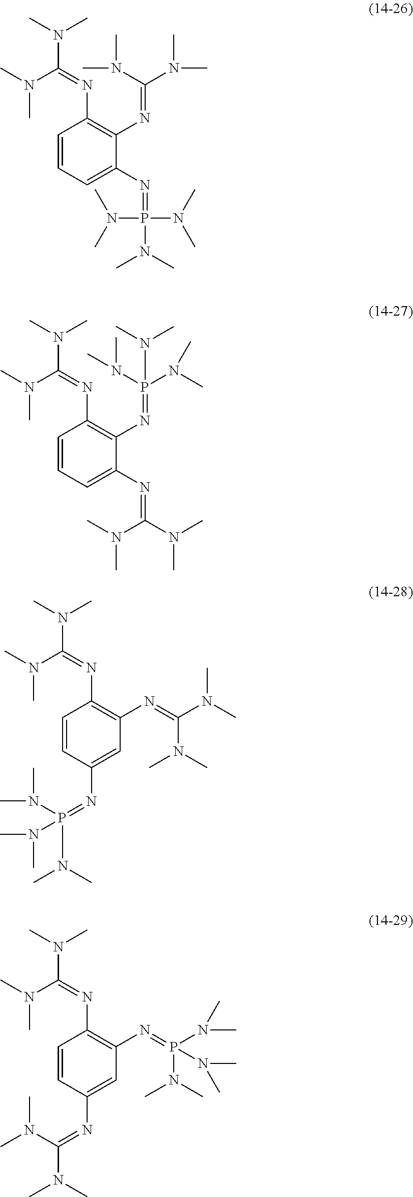

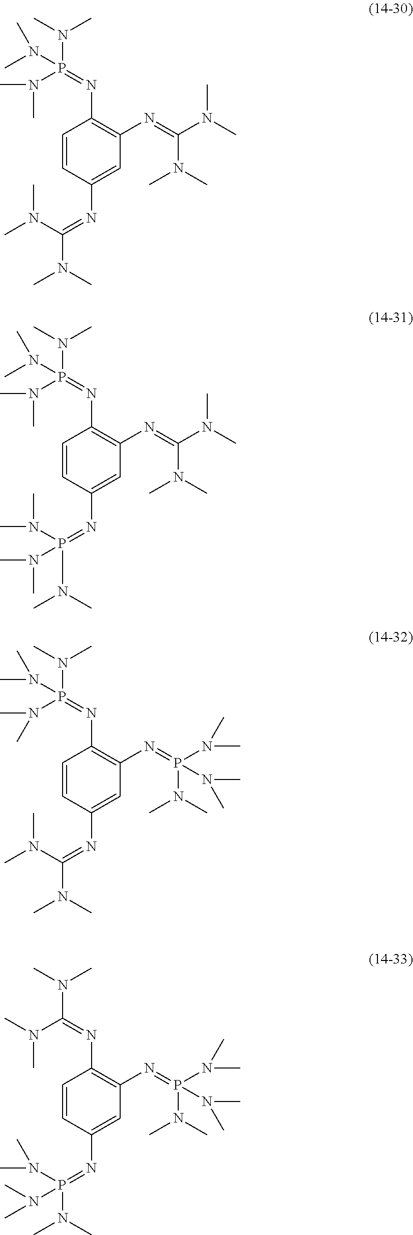

Also, specific examples of the nitrogen-containing aromatic compound are at least one of compounds represented by the following formulae (15-1) to (15-7). However, M3 shown in the formulae (15-1) to (15-7) represents N, O, or S. The aromatic skeleton of this nitrogen-containing aromatic compound is pyrrole (M3=N), furan (M3=O), or thiophene (M3=S).

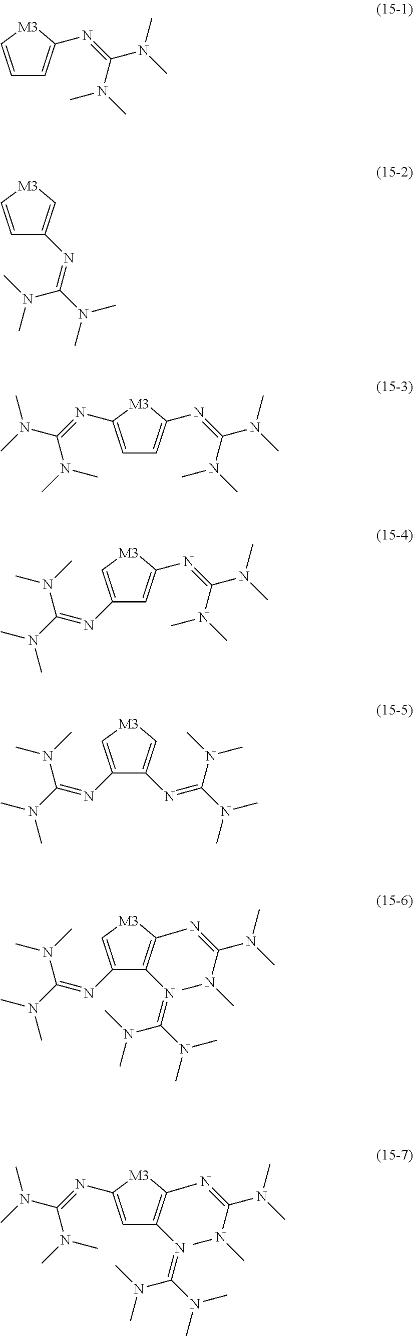

Also, specific examples of the nitrogen-containing aromatic compound are at least one of compounds represented by the following formulae (16-1) to (16-42). The aromatic skeleton of this nitrogen-containing aromatic compound is naphthalene.

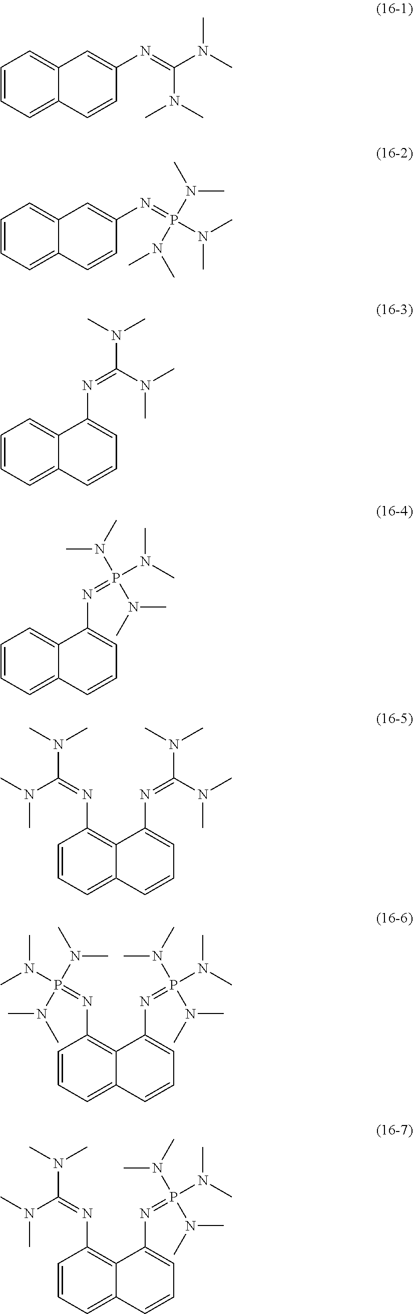

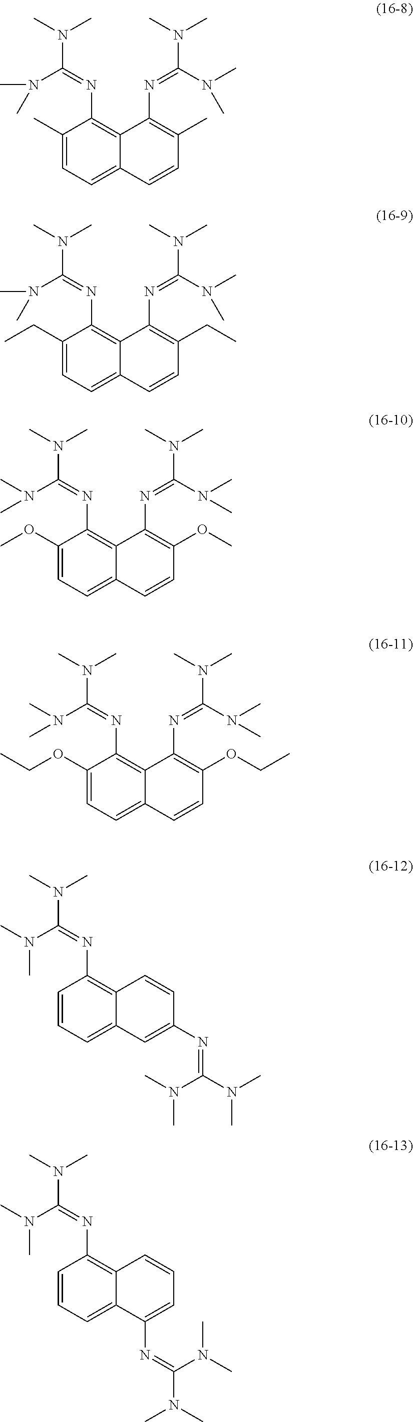

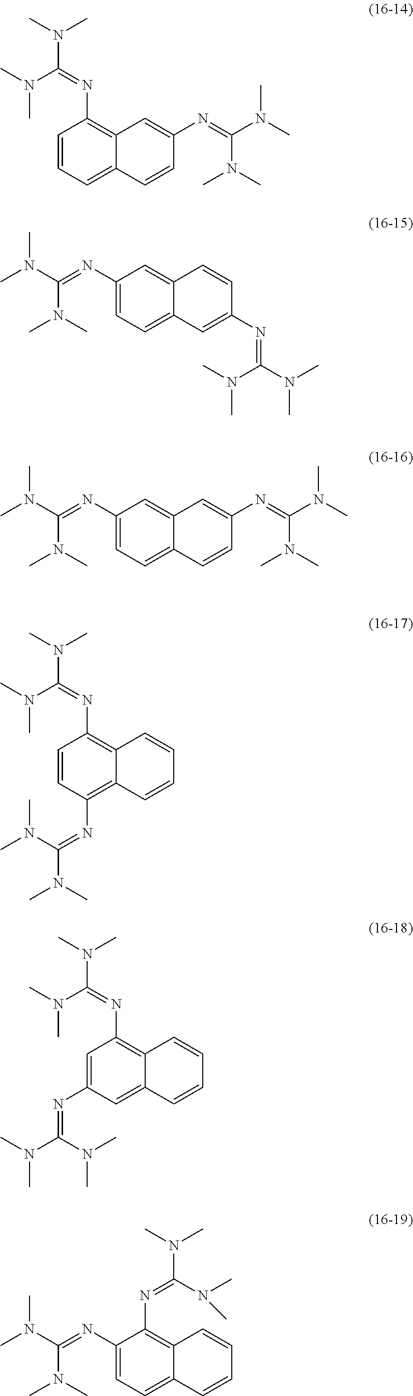

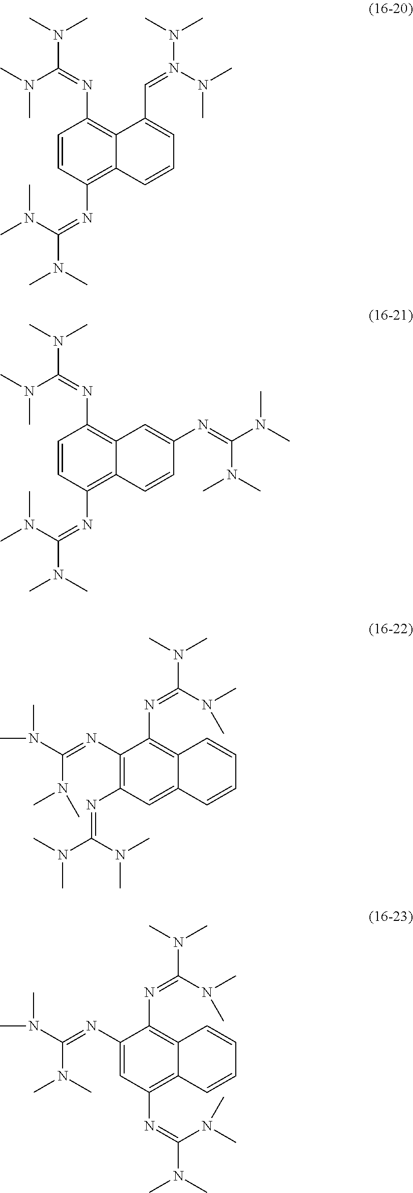

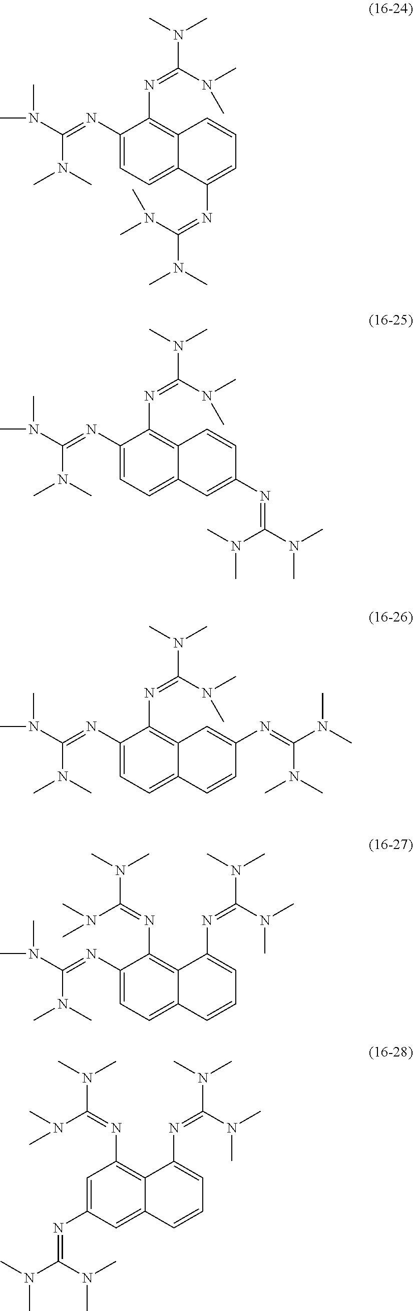

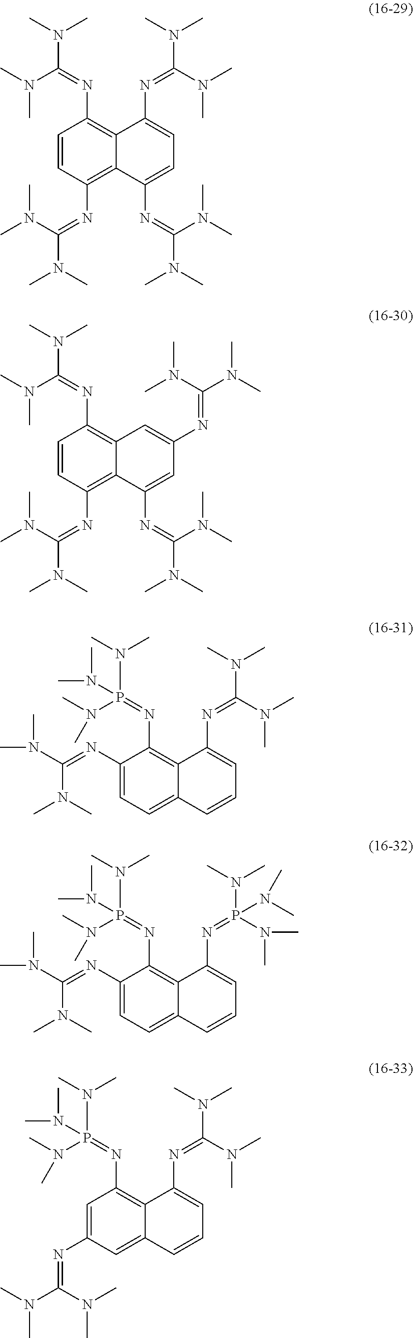

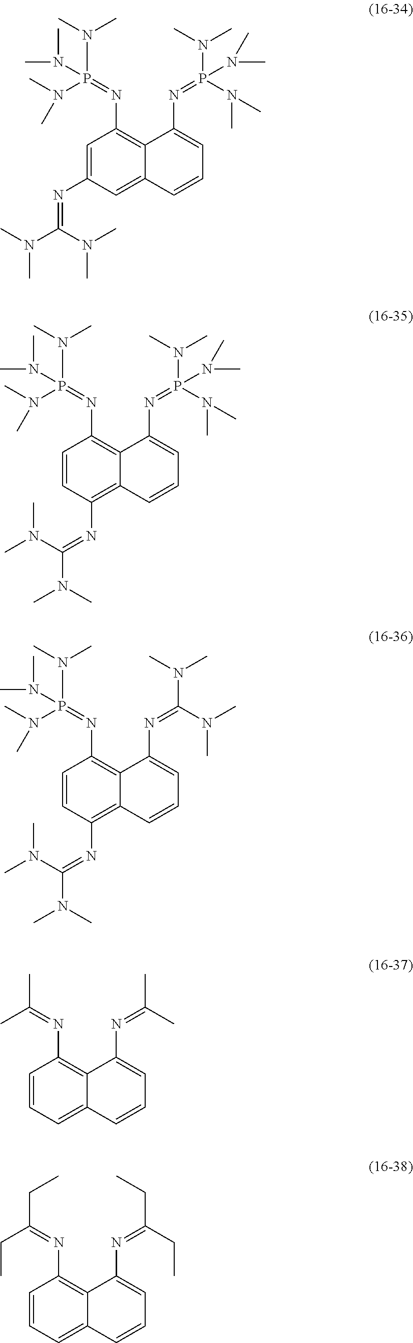

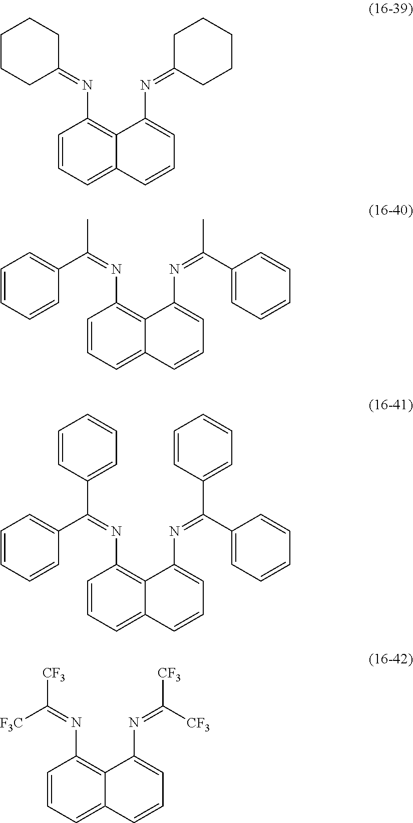

Also, specific examples of the nitrogen-containing aromatic compound are at least one of compounds represented by the following formulae (17-1) to (17-9). The aromatic skeleton of this nitrogen-containing aromatic compound is biphenyl.

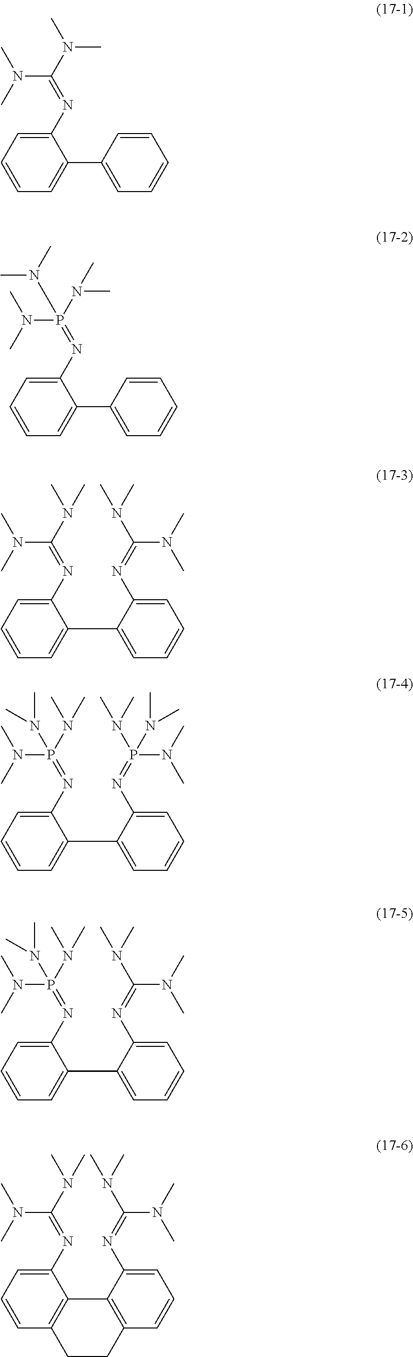

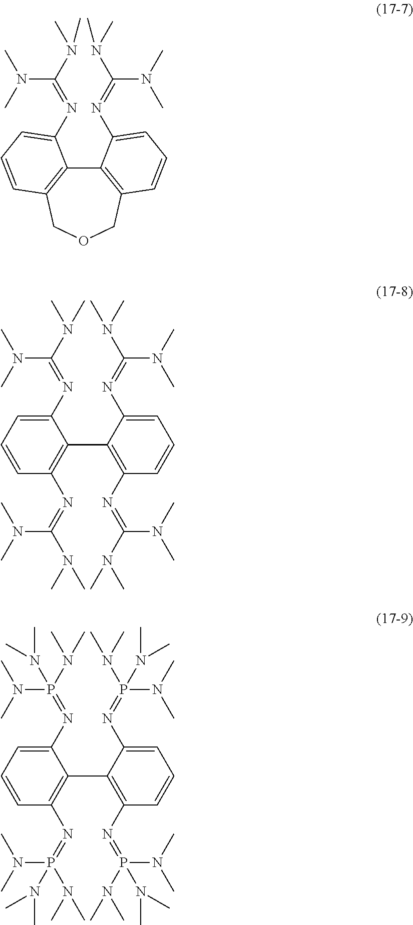

Also, specific examples of the nitrogen-containing aromatic compound are at least one of compounds represented by the following formulae (18-1) to (18-8). The aromatic skeleton of this nitrogen-containing aromatic compound is phenanthrene.

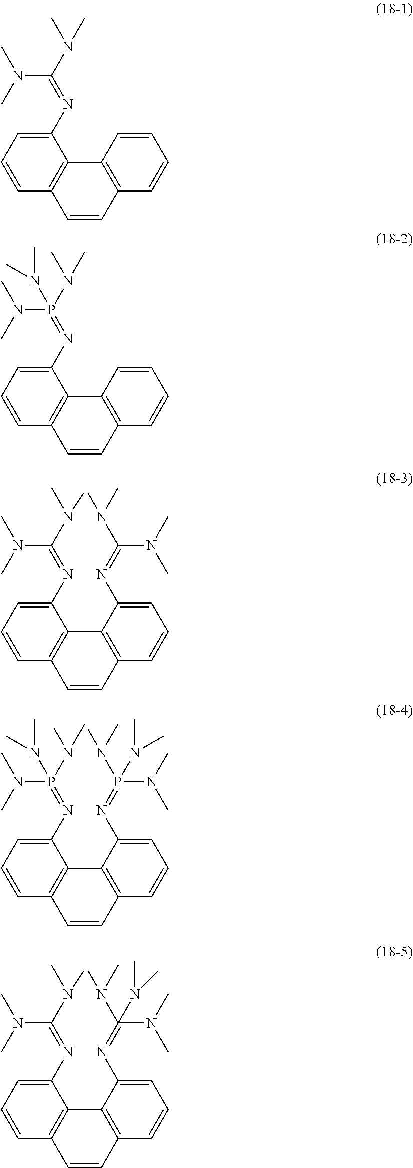

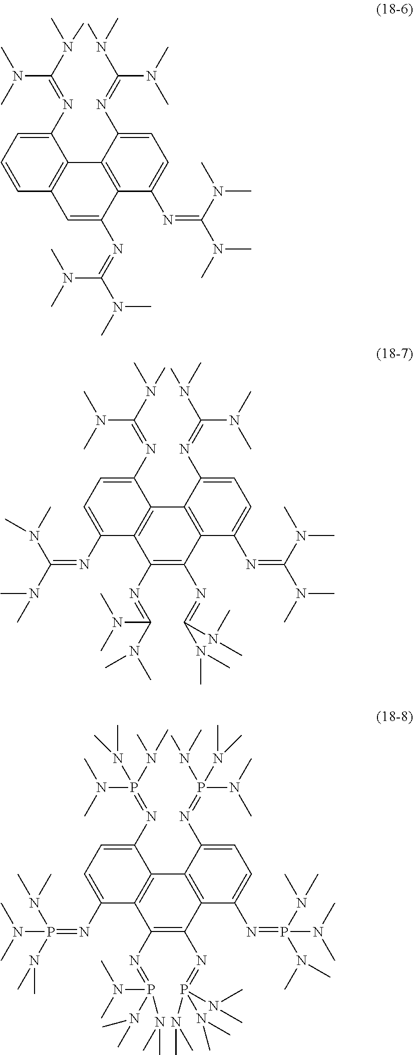

Also, specific examples of the nitrogen-containing aromatic compound are at least one of compounds represented by the following formulae (19-1) to (19-20). The aromatic skeleton of this nitrogen-containing aromatic compound is heterofluorene.

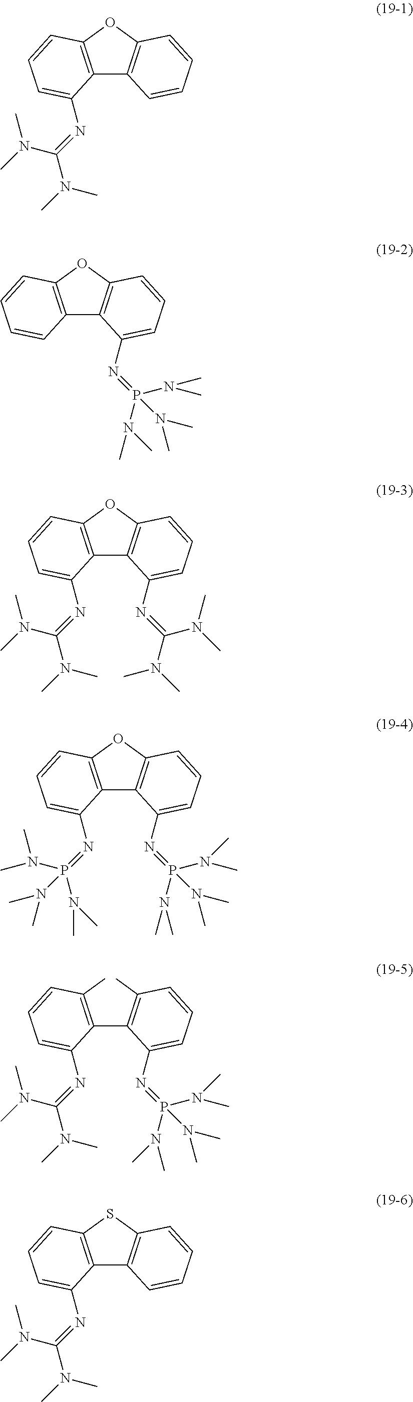

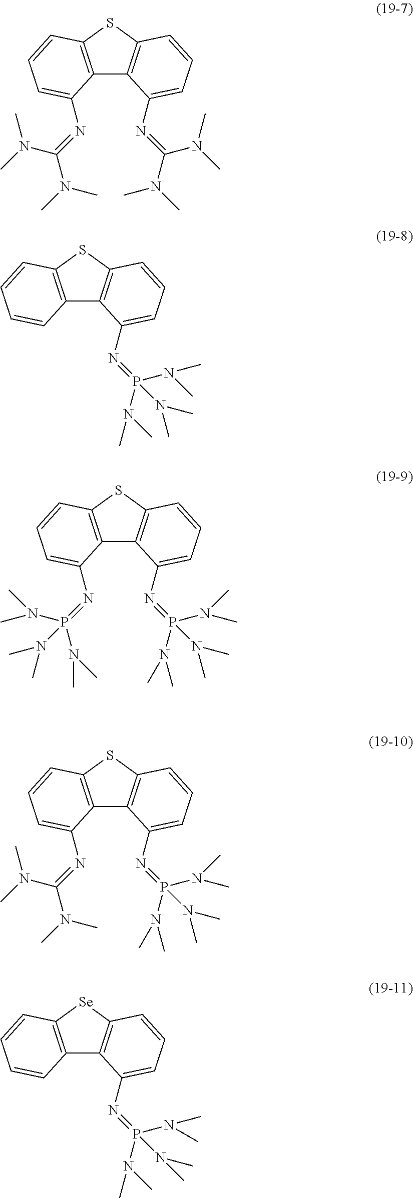

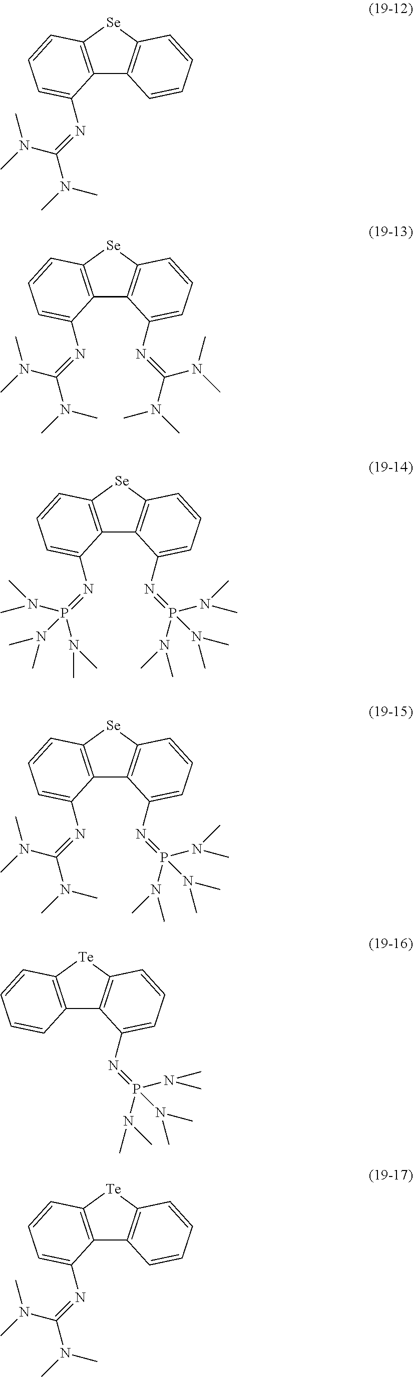

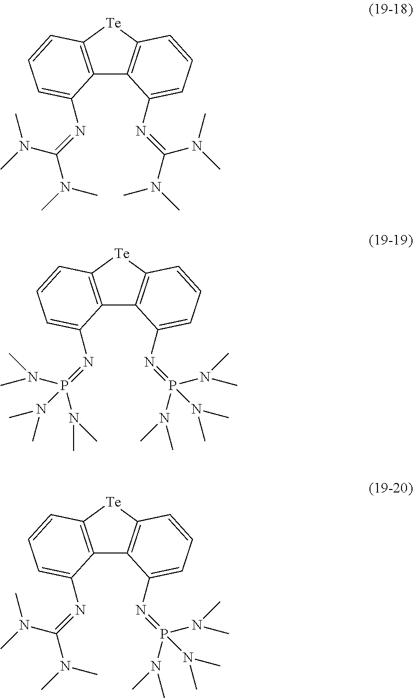

In particular, among the specific examples of the foregoing series of nitrogen-containing aromatic compounds, those corresponding to any one of the formulae (2) to (5) or any one of the formulae (6) to (13) are preferable. This is because higher effects are obtainable.

Here, the number of carbon atoms between the foregoing two nitrogen-containing functional groups is specifically described. When an example is taken, the number of carbon atoms counted from a carbon atom in the ring to which one of the nitrogen-containing functional groups is bonded to a carbon atom in other ring to which the other nitrogen-containing function group is bonded such that the number of carbon atoms becomes the smallest is 3 in the formula (16-5), 4 in the formula (16-14), 5 in the formula (16-16), and 6 in the formula (16-15), respectively.

Though a content of the nitrogen-containing aromatic compound in the electrolytic solution is not particularly limited, it is from 0.0001% by weight to 15% by weight, preferably from 0.001% to 10% by weight, and more preferably from 0.01% by weight to 5% by weight. This is because higher effects are obtainable.

### [Solvent]

For example, the solvent contains any one kind or two or more kinds of nonaqueous solvents such as the following organic solvents. That is, examples thereof include ethylene carbonate, propylene carbonate, butylene carbonate, dimethyl carbonate, diethyl carbonate, ethylmethyl carbonate, methylpropyl carbonate, γ-butyrolactone, γ-valerolactone, 1,2-dimethoxyethane, and tetrahydrofuran. Also, examples thereof include 2-methyltetrahydrofuran, tetrahydropyran, 1,3-dioxolane, 4-methyl-1,3-dioxolane, 1,3-dioxane, and 1,4-dioxane. Also, examples thereof include methyl acetate, ethyl acetate, methyl propionate, ethyl propionate, methyl butyrate, methyl isobutyrate, methyl trimethylacetate, and ethyl trimethylacetate. Also, examples thereof include acetonitrile, glutaronitrile, adiponitrile, methoxyacetonitrile, 3-methoxypropionitrile, N,N-dimethylformamide, N-methylpyrrolidinone, and N-methyloxazolidinone. Also, examples thereof include N,N′-dimethylimidazolidinone, nitromethane, nitroethane, sulfolane, trimethyl phosphate, and dimethyl sulfoxide. This is because excellent battery capacity, cycle characteristic, and storage characteristic, and so on are obtainable.

Above all, at least one member selected from the group consisting of ethylene carbonate, propylene carbonate, dimethyl carbonate, diethyl carbonate, and ethylmethyl carbonate is preferable. This is because more excellent characteristics are obtainable. In that case, a combination of a solvent with a high viscosity (high dielectric constant) (for example, relative dielectric constant ∈≧30), such as ethylene carbonate and propylene carbonate, and a solvent with a low viscosity (for example, viscosity ≦1 mPa·s), such as dimethyl carbonate, ethylmethyl carbonate, and diethyl carbonate, is more preferable. This is because dissociation properties of the electrolyte salt and mobility of the ion are enhanced.

In particular, it is preferable that the solvent contains an unsaturated carbon-bonding cyclic carbonate. This is because a stable protective film is formed on the surface of the negative electrode 22 at the time of charge and discharge, and therefore, a decomposition reaction of the electrolytic solution is suppressed. The unsaturated carbon-bonding cyclic carbonate is a cyclic carbonate having one or two or more unsaturated carbon bonds, and examples thereof include vinylene carbonate and vinylethylene carbonate. Incidentally, a content of the unsaturated carbon-bonding cyclic carbonate in the nonaqueous solvent is, for example, from 0.01% by weight to 10% by weight. This is because a decomposition reaction of the electrolytic solution is suppressed without too much lowering the battery capacity.

Also, it is preferable that the solvent contains at least one of a halogenated chain carbonate and a halogenated cyclic carbonate. This is because a stable protective film is formed on the surface of the negative electrode 22 at the time of charge and discharge, and therefore, a decomposition reaction of the electrolytic solution is suppressed. The halogenated chain carbonate is a chain carbonate having one or two or more halogens as a constituent element, and the halogenated cyclic carbonate is a cyclic carbonate having one or two or more halogens as a constituent element. The kind of the halogen group is not particularly limited. Above all, a fluorine group, a chlorine group, and a bromine group are preferable, and a fluorine group is more preferable. This is because high effects are obtainable. As to the number of halogen groups, 2 is more preferable than 1, and furthermore, the number of halogen groups may be 3 or more. This is because a firmer and more stable protective film is formed, and therefore, a decomposition reaction of the electrolytic solution is more suppressed. Examples of the halogenated chain carbonate include fluoromethyl methyl carbonate, bis(fluoromethyl) carbonate, and difluoromethyl methyl carbonate. Examples of the halogenated cyclic carbonate include 4-fluoro-1,3-dioxolan-2-one and 4,5-difluoro-1,3-dioxolan-2-one. Incidentally, a content of the halogenated chain carbonate or halogenated cyclic carbonate in the solvent is, for example, from 0.01% by weight to 50% by weight, and preferably from 0.01% by weight to 30% by weight. This is because a decomposition reaction of the electrolytic solution is suppressed without too much lowering the battery capacity.

Also, the solvent may contain a sultone (a cyclic sulfonate). This is because the chemical stability of the electrolytic solution is enhanced. Examples of the sultone include propane sultone and propene sultone. Incidentally, a content of the sultone in the nonaqueous solvent is, for example, from 0.5% by weight to 5% by weight. This is because a decomposition reaction of the electrolytic solution is suppressed without too much lowering the battery capacity.

Furthermore, the solvent may contain an acid anhydride. This is because the chemical stability of the electrolytic solution is more enhanced. Examples of the acid anhydride include dicarboxylic acid anhydrides, disulfonic anhydrides, and carboxylic sulfonic anhydrides. Examples of the dicarboxylic acid anhydride include succinic anhydride, glutaric anhydride, and maleic anhydride. Examples of the disulfonic anhydride include ethanedisulfonic anhydride and propanedisulfonic anhydride. Examples of the carboxylic sulfonic anhydride include sulfobenzoic anhydride, sulfopropionic anhydride, and sulfobutyric anhydride. Incidentally, a content of the acid anhydride in the nonaqueous solvent is, for example, from 0.5% by weight to 5% by weight. This is because a decomposition reaction of the electrolytic solution is suppressed without too much lowering the battery capacity.

### [Electrolyte Salt]

For example, the electrolyte salt contains anyone kind or two or more kinds of the following Li salts. However, the electrolyte salt may be other salt than the Li salt (for example, light metal salts other than the Li salt).

Examples of the Li salt include LiPF₆, LiBF₄, LiClO₄, LiAsF₆, LiB(C₆H₅)₄, LiCH₃SO₃, LiCF₃SO₃, LiAlCl₄, Li₂SiF₆, LiCl, and LiBr. This is because excellent battery capacity, cycle characteristic, and storage characteristic, and so on are obtainable. Above all, at least one member selected from the group consisting of LiPF₆, LiBF₄, LiClO₄, and LiAsF₆ is preferable, and LiPF₆ is more preferable. This is because the internal resistance is lowered, and therefore, higher effects are obtainable.

Also, the Li salt may be, for example, at least one of compounds represented by the following formulae (21) and (22). This is because higher effects are obtainable.

LiPFₐ(CₘF₂ₘ₊₁)₆₋ₐ (21)

In the formula (21), a represents an integer of from 0 to 5; and n represents an integer of 1 or more.

LiBF_{b}(CₙF₂ₙ₊₁)_{4-b} (22)

In the formula (22), b represents an integer of from 0 to 3; and n represents an integer of 1 or more.

The Li salt represented by the formula (21) is a compound obtained by substituting a part of Fs in LiPF₆ with a perfluoroalkyl group. Specific examples of this Li salt include LiPF₃(CF₃)₃, LiPF₃(C₂F₅)₃, LiPF₃(n-C₃F₇)₃, LiPF₃(i-C₃F₇)₃, LiPF₃(n-C₄F₉)₃, LiPF₃(i-C₄F₉)₃, LiPF₄(CF₃)₂, LiPF₄(C₂F₅)₂, LiPF₄(n-C₃F₇)₂/LiPF₄(i-C₃F₇)₂/LiPF₄(n-C₄F₉)₂, and LiPF₄(i-C₄F₉)₂.

The Li salt represented by the formula (22) is a compound obtained by substituting a part of fluorines in LiBF₄ with a perfluoroalkyl group. Specific examples of this lithium salt include LiBF₃(CF₃), LiBF₃(C₂F₅), LiBF₃(C₃F₇), LiBF₂ (C₂F₅)₂, and LiB(CF₃)₄.

Also, the Li salt may be, for example, a compound represented by the following formula (23). This is because higher effects are obtainable. Incidentally, m and n may be the same value as or a different value from each other. This is also the same as to p, q, and r. However, the kind of the electrolyte salt is not limited to those described below but may be others.

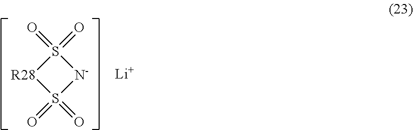

In the formula (23), R28 represents a linear or branched perfluoroalkylene group having a carbon number of from 2 to 4.

The compound represented by the formula (23) is a cyclic imide compound. Specific examples of this compound include compounds represented by the following formulae (23-1) to (23-4).

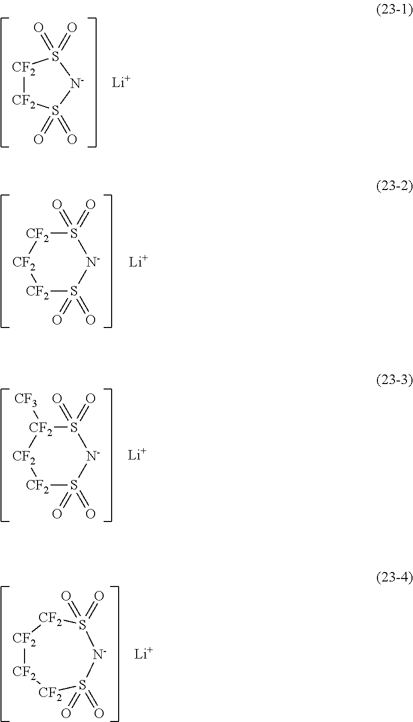

A content of the electrolyte salt is not particularly limited. Above all, it is preferably 0.3 moles/kg or more and not more than 3.0 moles/kg relative to the solvent. This is because high ionic conductivity is obtainable.

### [Motion of Secondary Battery]

In this secondary battery, for example, at the time of charge, a lithium ion deintercalated from the positive electrode 21 is intercalated in the negative electrode 22 via the electrolytic solution, and at the time of discharge, a lithium ion deintercalated from the negative electrode 22 is intercalated in the positive electrode 21 via the electrolytic solution. In that case, in order to obtain a high battery capacity, it is desirable to set up a charge termination voltage (open circuit voltage in a fully charged state) to 4.25 V or more, and preferably from 4.25 V to 6.00 V.

### [Manufacturing Method of Secondary Battery]

This secondary battery is, for example, manufactured by the following procedure.

In the case of fabricating the positive electrode 21, a positive electrode active material and optionally, a positive electrode binder, a positive electrode electrically conductive agent, and so on are mixed to form a positive electrode mixture. Subsequently, the positive electrode mixture is dispersed in an organic solvent, etc. to form a positive electrode mixture slurry in a paste form. Subsequently, the positive electrode mixture slurry is coated on the both surfaces of the positive electrode collector 21A and then dried to form the positive electrode active material layer 21B. Subsequently, the positive electrode active material layer 21B is subjected to compression molding by a roll press or the like while heating, if desired. In that case, the compression molding may be repeatedly carried out plural times.

The fabrication procedure of the negative electrode 22 is, for example, the same as the above-described fabrication procedure of the positive electrode 21. Specifically, a negative electrode active material and optionally, a negative electrode binder, a negative electrode electrically conductive agent, and so on are mixed to form a negative electrode mixture, which is then dispersed in an organic solvent, etc. to form a negative electrode mixture slurry in a paste form. Subsequently, the negative electrode mixture slurry is coated on the both surfaces of the negative electrode collector 22A and then dried to form the negative electrode active material layer 22B. Thereafter, the negative electrode active material layer 22B is subjected to compression molding, if desired.

Incidentally, the negative electrode 22 may be fabricated by a different procedure from that in the positive electrode 21. For example, a negative electrode material is deposited on the both surfaces of the negative electrode collector 22A by adopting a vapor phase method such as a vapor deposition method, thereby forming the negative electrode active material layer 22B.

In the case of preparing an electrolytic solution, after a solvent and a nitrogen-containing aromatic compound are mixed, an electrolyte salt is dissolved therein.

In the case of assembling a secondary battery, the positive electrode lead 25 is installed in the positive electrode collector 21A, and the negative electrode lead 26 is also installed in the negative electrode collector 22A, by adopting a welding method or the like. Subsequently, the separator 23 containing a polymer compound is prepared, the positive electrode 21 and the negative electrode 22 are laminated via the separator 23 and wound to fabricate the wound electrode body 20, and the center pin 24 is then inserted into the winding center thereof. Subsequently, the wound electrode body 20 is housed in the inside of the battery can 11 while being interposed between a pair of the insulating plates 12 and 13. In that case, a tip portion of the positive electrode lead 25 is installed in the safety valve mechanism 15, and a tip portion of the negative electrode lead 26 is also installed in the battery can 11, by adopting a welding method or the like. Subsequently, the electrolytic solution is injected into the inside of the battery can 11 and impregnated in the separator 23. Subsequently, the battery lid 14, the safety valve mechanism 15, and the positive temperature coefficient device 16 are fixed to the open end portion of the battery can 11 upon being caulked via the gasket 17.

### [Actions and Effects of Secondary Battery]

According to this secondary battery of a cylindrical type, since the electrolytic solution contains the foregoing nitrogen-containing aromatic compound, as described above, a decomposition reaction of the electrolytic solution in the high-temperature environment is suppressed, and an increase of resistance in the inside of the battery is also suppressed. Thus, the high-temperature characteristics can be enhanced. In particular, since the decomposition reaction of the electrolytic solution is markedly suppressed, even when the charge termination voltage is set to 4.25 V or more, the same effects can be obtained.

Besides, so far as the aromatic skeleton of the nitrogen-containing aromatic compound is naphthalene, biphenyl, phenanthrene, fluorene, or heterofluorene, higher effects can be obtained. Also, so far as Y in the formula (1) is an electron donating group such as at least one of a dialkylamino group and an aryl group, or the number of nitrogen-containing functional groups is 2 or more, higher effects can be obtained. Furthermore, so far as the aromatic ring contains two or more rings, and a value counted from a carbon atom in the ring to which one of the nitrogen-containing functional groups is bonded to a carbon atom in other ring to which the other nitrogen-containing function group is bonded such that the number of carbon atoms becomes the smallest is from 2 to 4, higher effects can be obtained. In addition, so far as a content of the nitrogen-containing aromatic compound in the electrolytic solution is from 0.0001% by weight to 15% by weight, preferably from 0.001% by weight to 10% by weight, and more preferably from 0.01% by weight to 5% by weight, higher effects can be obtained. Also, so far as the solvent of the electrolytic solution contains from 0.01% by weight to 30% by weight of a halogenated cyclic carbonate, or the separator 23 is of a laminated type or a mixed type formed of two or more kinds of polymer compounds, higher effects can be obtained.

### <1-2. Laminated Film Type>

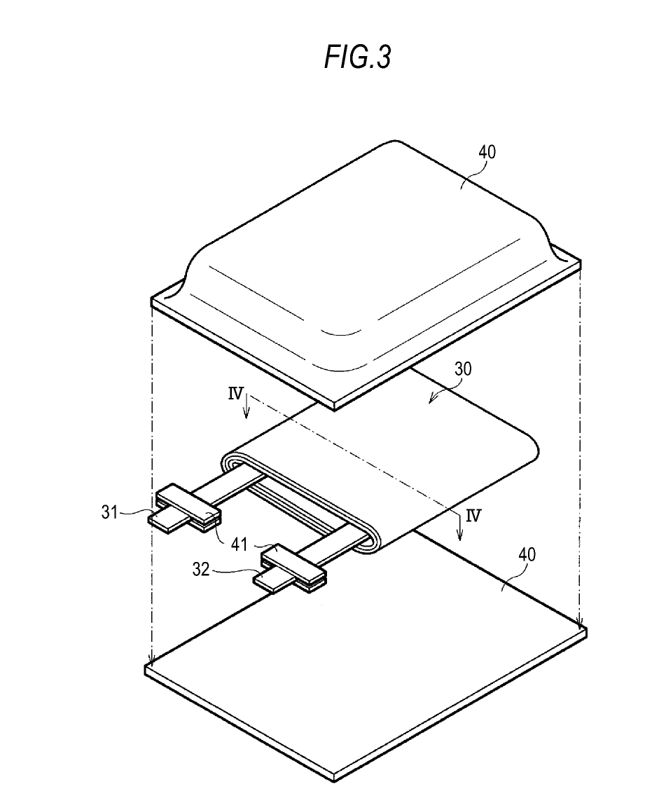

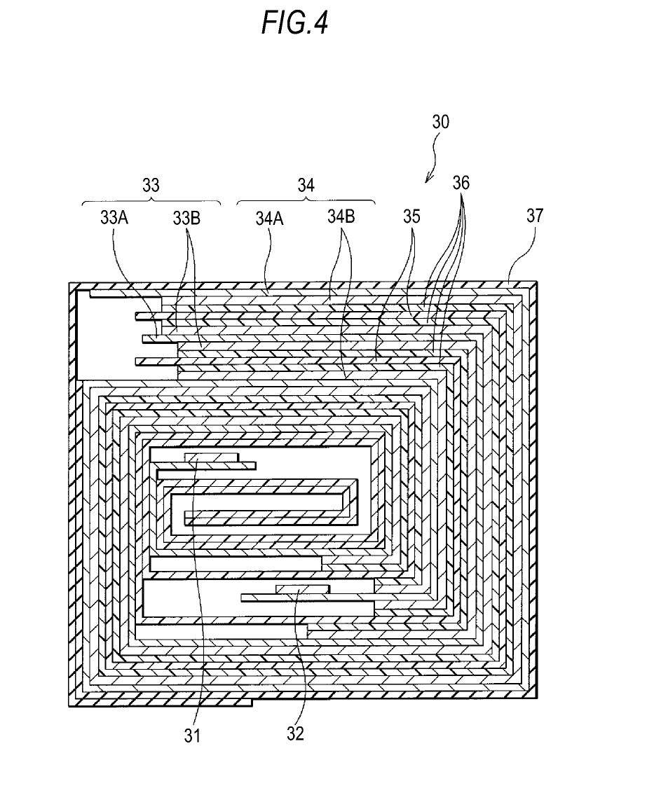

FIG. 3 shows an exploded perspective configuration of another secondary battery in an embodiment of the present technology; and FIG. 4 shows enlargedly a section along a IV-IV line of a wound electrode body 30 shown in FIG. 3. The constituent elements of the secondary battery of a cylindrical type as already described are hereunder autoed as needed.

### [Entire Configuration of Secondary Battery]

The secondary battery as described herein is of a so-called laminated film type, in which the wound electrode body 30 is housed in the inside of a package member 40 in a film form. In this wound electrode body 30, a positive electrode 33 and a negative electrode 34 are laminated via a separator 35 and an electrolyte layer 36 and wound. A positive electrode lead 31 is installed in the positive electrode 33, and a negative electrode lead 32 is also installed in the negative electrode 34. An outermost peripheral part of this wound electrode body 30 is protected by a protective tape 37.

The positive electrode lead 31 and the negative electrode lead 32 are each led out in, for example, the same direction from the inside toward the outside of the package member 40. The positive electrode lead 31 is, for example, formed of an electrically conductive material such as Al, and the negative electrode lead 32 is, for example, also formed of an electrically conductive material such as Cu, Ni, and stainless steel. Such a material is, for example, formed in a thin plate state or a network state.

The package member 40 is, for example, a laminated film obtained by laminating a fusible layer, a metal layer, and a surface protective layer in this order. In this laminated film, for example, the respective outer edges of two fusible layers in a film form are stuck to each other by means of fusion or with an adhesive in such a manner that the fusible layer is opposing to the would electrode body 30. The fusible layer is, for example, a film made of polyethylene, polypropylene, etc. The metal layer is, for example, an Al foil, etc. The surface protective layer is, for example, a film made of nylon, polyethylene terephthalate, etc.

Above all, the package member 40 is preferably an aluminum laminated film by laminating a polyethylene film, an aluminum foil, and a nylon film in this order. However, the package member 40 may be a laminated film having other laminate structure, or may be a polymer film made of polypropylene, etc. or a metal film.

A contact film 41 is inserted between the package member 40 and each of the positive electrode lead 31 and the negative electrode lead 32 for the purpose of preventing invasion of the outside air from occurring. This contact film 41 is formed of a material having adhesion to each of the positive electrode lead 31 and the negative electrode lead 32. Examples of such a material include polyolefin resins such as polyethylene, polypropylene, modified polyethylene, and modified polypropylene.

The positive electrode 33 is, for example, a positive electrode in which a positive electrode active material layer 33B is provided on the both surfaces of a positive electrode collector 33A. The negative electrode 34 is, for example, a negative electrode in which a negative electrode active material layer 34B is provided on the both surfaces of a negative electrode collector 34A. The configurations of the positive electrode collector 33A, the positive electrode active material layer 33B, the negative electrode collector 34A, and the negative electrode active material layer 34B are the same as those of the positive electrode collector 21A, the positive electrode active material layer 21B, the negative electrode collector 22A, and the negative electrode active material layer 22B, respectively. Also, the configuration of the separator 35 is the same as the configuration of the separator 23.

The electrolyte layer 36 is one in which the electrolytic solution is held by a polymer compound and may contain other materials such as additives, if desired. The electrolyte layer 36 is an electrolyte in a so-called gel form. This is because not only a high ionic conductivity (for example, 1 mS/cm or more at room temperature) is obtainable, but the liquid leakage of the electrolytic solution is prevented from occurring.

The polymer compound is, for example, any one kind or two or more kinds of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Also, examples thereof include polyvinyl acetate, polyvinyl alcohol, polymethyl methacrylate, polyacrylic acid, polymethacrylic acid, a styrene-butadiene rubber, a nitrile-butadiene rubber, polystyrene, and polycarbonate. Also, examples thereof include a copolymer of vinylidene fluoride and hexafluoropropylene. Above all, polyvinylidene fluoride and a copolymer of vinylidene fluoride and hexafluoropropylene are preferable, and polyvinylidene fluoride is more preferable. This is because these materials are electrochemically stable.

A composition of the electrolytic solution is the same as that in the case of a cylindrical type, and it contains a nitrogen-containing aromatic compound. However, in the electrolyte layer 36 that is an electrolyte in a gel form, the solvent of the electrolytic solution as referred to herein has a broad concept including not only a liquid solvent but a solvent with ionic conductivity such that it is able to dissociate the electrolyte salt. Accordingly, in the case of using a polymer compound with ionic conductivity, this polymer compound is also included in the solvent.

Incidentally, in place of the electrolyte layer 36 in a gel form, the electrolytic solution may be used as it is. In that case, the electrolytic solution is impregnated in the separator 35.

### [Motion of Secondary Battery]

In this secondary battery, for example, at the time of charge, a lithium ion deintercalated from the positive electrode 33 is intercalated in the negative electrode 34 via the electrolyte layer 36, and at the time of discharge, a lithium ion deintercalated from the negative electrode 34 is intercalated in the positive electrode 33 via the electrolyte layer 36. In that case, similar to the case of a cylindrical type, in order to obtain a high battery capacity, it is desirable to set up a voltage at the time of charge to 4.25 V or more, and preferably from 4.25 V to 6.00 V.

### [Manufacturing Method of Secondary Battery]

The secondary battery equipped with this electrolyte layer 36 in a gel form is, for example, manufactured according to the following three kinds of procedures.

In a first procedure, the positive electrode 33 and the negative electrode 34 are fabricated in the same fabrication procedure as that in the positive electrode 21 and the negative electrode 22. In that case, the positive electrode active material layer 33B is formed on the both surfaces of the positive electrode collector 33A to fabricate the positive electrode 33, and the negative electrode active material layer 34B is also formed on the both surfaces of the negative electrode collector 34A to fabricate the negative electrode 34. Subsequently, a precursor solution containing an electrolytic solution containing a nitrogen-containing aromatic compound, a polymer compound, and a solvent such as an organic solvent is prepared, and the precursor solution is then coated on the positive electrode 33 and the negative electrode 34 to form the electrolyte layer 36 in a gel form. Subsequently, the positive electrode lead 31 is installed in the positive electrode collector 33A, and the negative electrode lead 32 is also installed in the negative electrode collector 34A, by adopting a welding method or the like. Subsequently, the positive electrode 33 and the negative electrode 34, on each of which is formed the electrolyte layer 36, are laminated via the separator 35 and wound to fabricate the wound electrode body 30, and the protective tape 37 is stuck onto an outermost peripheral part thereof. Subsequently, the wound electrode body 30 is interposed between the two package members 40 in a film form, and the outer edges of the package members 40 are allowed to adhere to each other by adopting a heat fusion method or the like, thereby sealing the wound electrode body 30 therein. In that case, the contact film 41 is inserted between each of the positive electrode lead 31 and the negative electrode lead 32 and the package member 40.

In a second procedure, the positive electrode lead 31 is installed in the positive electrode 33, and the negative electrode lead 32 is also installed in the negative electrode 34. Subsequently, the positive electrode 33 and the negative electrode 34 are laminated via the separator 35 and wound, thereby fabricating a wound body that is a precursor of the wound electrode body 30, and the protective tape 37 is then stuck to an outermost peripheral part thereof. Subsequently, the wound body is interposed between the two package members 40 in a film form, and the outer edges exclusive of one side are allowed to adhere to each other by adopting a heat fusion method or the like, thereby housing the wound body in the inside of the package member 40 in a bag form. Subsequently, an electrolyte composition containing an electrolytic solution, a monomer that is a raw material of a polymer compound, and a polymerization initiator, and optionally, other materials such as a polymerization inhibitor is prepared and injected into the inside of the package member 40 in a bag form. Thereafter, the package member 40 is hermetically sealed by adopting a heat fusion method or the like. Subsequently, the monomer is heat polymerized. There is thus formed a polymer compound, whereby the electrolyte layer 36 in a gel form is formed.

In a third procedure, a wound body is formed and housed in the inside of the package member 40 in a bag form in the same manner as that in the foregoing second procedure, except for using the separator 35 having a polymer compound formed on the both surfaces thereof. Examples of the polymer compound to be coated on this separator 35 include polymers composed of, as a component, vinylidene fluoride (for example, a homopolymer, a copolymer, a multi-component copolymer, etc.). Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene, and chlorotrifluoroethylene. Incidentally, one kind or two or more kinds of other polymer compounds may be used together with the polymer composed of, as a component, vinylidene fluoride. Subsequently, an electrolytic solution is prepared and injected into the inside of the package member 40, and an opening of the package member 40 is then hermetically sealed by a heat fusion method or the like. Subsequently, the separator 35 is brought into intimate contact with each of the positive electrode 33 and the negative electrode 34 via the polymer compound upon heating while adding a weight to the package member 40. According to this, since the electrolytic solution is impregnated into the polymer compound, the polymer compound is gelled, whereby the electrolyte layer 36 is formed.

In this third procedure, swelling of the secondary battery is suppressed as compared with the first procedure. Also, in comparison with the second procedure, in the third procedure, the monomer that is a raw material of the polymer compound, or the solvent, or the like does not substantially remain in the electrolyte layer 36, and therefore, the forming step of a polymer compound is controlled well. For that reason, sufficient adhesion between each of the positive electrode 33 and the negative electrode 34 and each of the separator 35 and the electrolyte layer 36 is obtained.

### [Actions and Effects of Secondary Battery]

According to this secondary battery of a laminated film type, since the electrolytic solution has the same composition as that in the foregoing secondary battery of a cylindrical type, the high-temperature characteristics can be enhanced for the same reasons. In particular, in a laminated film type, battery swelling is easily generated upon being influenced by a gas produced due to a decomposition reaction of the electrolytic solution, and therefore, the battery swelling can be suppressed. Other actions and effects are the same as those in the cylindrical type.

### <2. Use of Secondary Battery>

Next, application examples of the secondary battery are described.

The use of this secondary battery is not particularly limited so far as it is concerned with machines, appliances, instruments, apparatuses, systems (assemblies of plural appliances, etc.), etc., for which the secondary battery is used as an electric power source for driving, an electric power storage source for electric power storage, or the like. In the case where the secondary battery is used as an electric power source, it may be used as a main electric power source (electric power source to be preferentially used), or may be used as an auxiliary electric power source (electric power source to be used in place of the main electric power source or upon being switched from the main electric power source). In the latter course, the main electric power source is not limited to the secondary battery.

Examples of the use of the secondary battery include the following uses. That is, examples thereof include electronic appliances such as a video camera, a digital still camera, a mobile phone, a laptop computer, a cordless phone, a headphone stereo player, a portable radio, a portable television set, and a personal digital assistant (PDA). Incidentally, the electronic appliance also includes life electric instruments such as an electric shaver, storage devices such as a backup electric power source and a memory card, and medical electronic appliances such as a pacemaker and a hearing aid. Also, examples thereof include power tools such as a power drill and a power saw. Also, examples thereof include electric vehicles such as an electric car (inclusive of a hybrid car). Also, examples thereof include electric power storage systems such as a household battery system for storing an electric power against an emergency, etc.

Above of all, the secondary battery is effectively applied to an electronic appliance, a power tool, an electric vehicle, an electric power storage system, and so on. This is because the secondary battery is required to have excellent characteristics, and therefore, by using the secondary battery of the present technology, it is possible to contrive to effectively enhance the characteristics. Incidentally, the electronic appliance is one to carryout various functions (for example, music regeneration, etc.) while using a secondary battery as an electric power source for operation. The power tool is one to move a movable part (for example, a drill, etc.) while using a secondary battery as an electric power source for driving. The electric vehicle is one to run while using a secondary battery as an electric power source for driving, and as described above, it may be a car which is also equipped with a driving source other than the secondary battery (for example, a hybrid car, etc.). The electric power storage system is a system using a secondary battery as an electric power storage source. For example, in a household electric power storage system, an electric power is stored in a secondary battery that is an electric power storage source, and in view of the fact that the electric power stored in the secondary battery is consumed depending on the situation, various appliances such as household electric products can be used.

### EXAMPLES

Examples of the present technology are hereunder specifically described in detail.

### Examples 1-1 to 1-46

Lithium ion secondary batteries of a cylindrical type as shown in FIGS. 1 and 2 were fabricated according to the following procedure.

In the case of fabricating a positive electrode 21, 94 parts by mass of a positive electrode active material (LiCoO₂), 3 parts by mass of a positive electrode binder (polyvinylidene fluoride: PVDF), and 3 parts by mass of a positive electrode electrically conductive agent (ketjen black that is an amorphous carbon powder) were mixed to form a positive electrode mixture. Subsequently, the positive electrode mixture was dispersed in an organic solvent (N-methyl-2-pyrrolidone: NMP) to prepare a positive electrode mixture slurry in a paste form. Subsequently, the positive electrode mixture slurry was uniformly coated on the both surfaces of a positive electrode collector 21A (strip-shaped aluminum foil: thickness=20 μm) by a coating apparatus and then dried, thereby forming a positive electrode active material layer 21B. Finally, the positive electrode active material layer 21B was subjected to compression molding by a roll press.

In the case of fabricating a negative electrode 22, 90 parts by mass of a negative electrode active material (graphite) and 10 parts by mass of a negative electrode binder (PVDF) were mixed to form a negative electrode mixture. Subsequently, the negative electrode mixture was dispersed in an organic solvent (NMP) to prepare a negative electrode mixture slurry in a paste form. Subsequently, the negative electrode mixture slurry was uniformly coated on the both surfaces of a negative electrode collector 22A (strip-shaped electrolytic copper foil: thickness=15 μm) by a coating apparatus and then dried, thereby forming a negative electrode active material layer 22B. Finally, the negative electrode active material layer 22B was subjected to compression molding by a roll press. In the case of fabricating this negative electrode 22, a filling amount of the negative electrode active material was adjusted such that a lithium metal did not deposit on the negative electrode 22 on the way of charge.

In the case of preparing an electrolytic solution, after mixing a mixed solvent with a nitrogen-containing aromatic compound depending on the situation, an electrolyte salt (LiPF₆) was dissolved therein. The kind of the nitrogen-containing aromatic compound is shown in Tables 1 and 2, respectively. Incidentally, the “carbon number” shown in each of Tables 1 and 2 is a carbon number (minimum value) between the two nitrogen-containing functional groups. A composition of the mixed solvent was composed of ethylene carbonate (EC)/propylene carbonate (PC)/dimethyl carbonate (DMC)/ethylmethyl carbonate (EMC)/4-fluoro-1,3-dioxolan-2-one (FEC) of 20/5/60/5/10. A content of the nitrogen-containing aromatic compound in the electrolytic solution was 1% by weight, and a concentration of the electrolyte salt in the electrolytic solution was 1.2 moles/kg.

In assembling a secondary battery, an Al-made positive electrode lead 25 was welded to the positive electrode collector 21A, and an Ni-made negative electrode lead 26 was also welded to the negative electrode collector 22A. Subsequently, the positive electrode 21 and the negative electrode 22 were laminated via a separator 23 and wound, and a winding end portion was fixed by an adhesive tape to fabricate a wound electrode body 20 of a jelly roll type (outer diameter=17.5 mm). As this separator 23, a single-layer porous film (thickness=16 μm) made of polyethylene (PE) was used. Subsequently, a center pin 24 was inserted into the winding center of the wound electrode body 20. Subsequently, the wound electrode body 20 was housed in the inside of an Fe-made battery can 11 plated with Ni while being interposed between a pair of insulating plates 12 and 13. In that case, a tip portion of the positive electrode lead 25 was welded to a safety valve mechanism 15, and a tip portion of the negative electrode lead 26 was also welded to the battery can 11. Subsequently, the electrolytic solution was injected into the inside of the battery can 11 in a reduced pressure system and impregnated in the separator 23. Finally, a battery lid 14, the safety valve mechanism 15, and a positive temperature coefficient device 16 were fixed to the open end portion of the battery can 11 upon being caulked via a gasket 17. There was thus completed a secondary battery of a cylindrical type (18 mm in diameter×65 mm in height).

As high-temperature characteristics of the secondary battery, a cycle characteristic in the high-temperature environment was examined. As a result, there were obtained results shown in Tables 1 and 2. In that case, the secondary battery was subjected to one cycle of charge and discharge in a high-temperature environment (at 50° C.), thereby measuring a discharge capacity, and thereafter, the secondary battery was subjected to 200 cycles of charge and discharge in the same environment, thereby measuring a discharge capacity. From this result, a capacity retention rate (%) was calculated according to the following expression.

Capacity retention rate[%]={(Discharge capacity at the 200th cycle)/(Discharge capacity at the first cycle)}×100

At the time of charge, the secondary battery was subjected to constant-current charge at a current density of 1 mA/cm² until the voltage reached 4.2 V; and the secondary battery was further subjected to constant-voltage charge at a voltage of 4.2 V for 5 hours. At the time of discharge, the secondary battery was subjected to constant-current discharge at a current density of 1 mA/cm² until the voltage reached 3.0 V.

TABLE 1

| | Negative | | | | Capacity |
|---|---|---|---|---|---|
| | electrode | Nitrogen-containing aromatic compound | | | retention |
| | active | | Carbon | Content | rate |
| | material | Kind | number | (% by weight) | (%) |
| Example 1-1 | Graphite | Formula (14-1) | — | 1 | 84 |
| Example 1-2 | | Formula (14-3) | — | | 85 |
| Example 1-3 | | Formula (14-11) | — | | 84 |
| Example 1-4 | | Formula (14-14) | — | | 85 |
| Example 1-5 | | Formula (14-15) | — | | 86 |
| Example 1-6 | | Formula (14-19) | — | | 86 |
| Example 1-7 | | Formula (14-23) | — | | 86 |
| Example 1-8 | | Formula (15-3), M3 = N | — | | 85 |
| Example 1-9 | | Formula (15-3), M3 = O | — | | 85 |
| Example 1-10 | | Formula (15-3), M3 = S | — | | 85 |
| Example 1-11 | | Formula (15-7), M3 = N | — | | 86 |
| Example 1-12 | | Formula (15-7), M3 = O | — | | 86 |
| Example 1-13 | | Formula (15-7), M3 = S | — | | 86 |
| Example 1-14 | | Formula (16-3) | — | | 88 |
| Example 1-15 | | Formula (16-4) | | | 88 |
| Example 1-16 | | Formula (16-5) | 3 | | 91 |
| Example 1-17 | | Formula (16-6) | 3 | | 91 |
| Example 1-18 | | Formula (16-7) | 3 | | 90 |
| Example 1-19 | | Formula (16-8) | 3 | | 91 |
| Example 1-20 | | Formula (16-9) | 3 | | 92 |
| Example 1-21 | | Formula (16-10) | 3 | | 91 |
| Example 1-22 | | Formula (16-11) | 3 | | 91 |
| Example 1-23 | | Formula (16-14) | 4 | | 91 |

TABLE 2

| | Negative | | | | Capacity |
|---|---|---|---|---|---|
| | electrode | Nitrogen-containing aromatic compound | | | retention |
| | active | | Carbon | Content | rate |
| | material | Kind | number | (% by weight) | (%) |
| Example 1-24 | Graphite | Formula (16-15) | 6 | 1 | 88 |
| Example 1-25 | | Formula (16-16) | 5 | | 88 |
| Example 1-26 | | Formula (16-20) | 3 | | 91 |
| Example 1-27 | | Formula (16-29) | 3 | | 92 |
| Example 1-28 | | Formula (16-37) | 3 | | 91 |
| Example 1-29 | | Formula (16-38) | 3 | | 89 |
| Example 1-30 | | Formula (16-39) | 3 | | 89 |
| Example 1-31 | | Formula (16-40) | 3 | | 91 |
| Example 1-32 | | Formula (16-41) | 3 | | 91 |
| Example 1-33 | | Formula (16-42) | 3 | | 89 |
| Example 1-34 | | Formula (17-3) | 4 | | 90 |
| Example 1-35 | | Formula (17-4) | 4 | | 90 |
| Example 1-36 | | Formula (17-5) | 4 | | 90 |
| Example 1-37 | | Formula (17-6) | 4 | | 90 |
| Example 1-38 | | Formula (17-7) | 4 | | 90 |
| Example 1-39 | | Formula (17-9) | 4 | | 91 |
| Example 1-40 | | Formula (18-4) | 4 | | 90 |
| Example 1-41 | | Formula (18-7) | 3 | | 91 |
| Example 1-42 | | Formula (19-4) | 4 | | 90 |
| Example 1-43 | | Formula (19-7) | 4 | | 90 |
| Example 1-44 | | Formula (19-11) | — | | 89 |
| Example 1-45 | | Formula (19-18) | 4 | | 89 |
| Example 1-46 | | — | — | | 81 |

In the case where the electrolytic solution contained a nitrogen-containing aromatic compound, the capacity retention rate was remarkably high as compared with the case where the electrolytic solution did not contain a nitrogen-containing aromatic compound. In particular, in the case where the nitrogen-containing aromatic compound contained plural nitrogen-containing functional groups, when the carbon number was from 2 to 4, higher effects were obtained.

### Examples 2-1 to 2-8

Secondary batteries were fabricated in the same procedure as that in Example 1-17, except for changing the content of the nitrogen-containing aromatic compound, and their high-temperature characteristics were examined. As a result, results shown in Table 3 were obtained.

TABLE 3

| | Negative | Nitrogen-containing | | Capacity |
|---|---|---|---|---|
| | electrode | aromatic compound | | retention |
| | active | | Content | rate |
| | material | Kind | (% by weight) | (%) |
| Example 2-1 | Graphite | Formula | 0.0001 | 84 |
| Example 2-2 | | (16-6) | 0.001 | 88 |
| Example 2-3 | | | 0.01 | 90 |
| Example 2-4 | | | 0.5 | 91 |
| Example 2-5 | | | 2 | 91 |
| Example 2-6 | | | 5 | 90 |
| Example 2-7 | | | 10 | 88 |
| Example 2-8 | | | 15 | 85 |

Even when the content of the nitrogen-containing aromatic compound was changed, the same results shown in Tables 1 and 2 were obtained. In particular, when the content of the nitrogen-containing aromatic compound was from 0.0001% by weight to 15% by weight, preferably from 0.001% by weight to 10% by weight, and more preferably from 0.01% by weight to 5% by weight, a higher capacity retention rate was obtained.

### Examples 3-1 to 3-14

Secondary batteries were fabricated in the same procedure as that in Example 1-17 or 1-46, except for changing the composition of the mixed solvent of the electrolytic solution, and their high-temperature characteristics were examined. As a result, results shown in Table 4 were obtained. In addition to FEC, 4,5-difluoro-1,3-dioxolan-2-one (DFEC) was used as the halogenated cyclic carbonate.

TABLE 4

| | Negative | Nitrogen-containing | | | | | | | | Capacity |
|---|---|---|---|---|---|---|---|---|---|---|
| | electrode | aromatic compound | | | | | | | | retention |
| | active | | Content | Solvent (% by weight) | | | | | | rate |
| | material | Kind | (% by weight) | EC | PC | DMC | EMC | FEC | DPEC | (%) |
| Example 3-1 | Graphite | Formula | 1 | 30 | 5 | 60 | 5 | 0 | 0 | 89 |
| Example 3-2 | | (16-6) | | 29 | 5 | 60 | 5 | 1 | 0 | 90 |
| Example 3-3 | | | | 25 | 5 | 60 | 5 | 5 | 0 | 91 |
| Example 3-4 | | | | 10 | 5 | 60 | 5 | 20 | 0 | 91 |
| Example 3-5 | | | | 0 | 5 | 60 | 5 | 30 | 0 | 90 |
| Example 3-6 | | | | 0 | 0 | 60 | 5 | 35 | 0 | 89 |
| Example 3-7 | | | | 20 | 5 | 60 | 5 | 0 | 10 | 91 |
| Example 3-8 | Graphite | — | — | 30 | 5 | 60 | 5 | 0 | 0 | 78 |
| Example 3-9 | | | | 29 | 5 | 60 | 5 | 1 | 0 | 79 |
| Example 3-10 | | | | 25 | 5 | 60 | 5 | 5 | 0 | 80 |
| Example 3-11 | | | | 10 | 5 | 60 | 5 | 20 | 0 | 81 |
| Example 3-12 | | | | 0 | 5 | 60 | 5 | 30 | 0 | 80 |
| Example 3-13 | | | | 0 | 0 | 60 | 5 | 35 | 0 | 78 |
| Example 3-14 | | | | 20 | 5 | 60 | 5 | 0 | 10 | 81 |

Even when the composition of the electrolytic solution was changed, the same results shown in Tables 1 and 2 were obtained. In particular, when the halogenated cyclic carbonate (FEC or DFEC) was used, the capacity retention rate became higher.

### Examples 4-1 to 4-8

Secondary batteries were fabricated in the same procedure as that in Example 1-17 or 1-46, except for changing the configuration of the separator 23, and their high-temperature characteristics were examined. As a result, results shown in Table 5 were obtained. In addition to PE, PVDF or polypropylene (PP) was used as the forming material of the separator 23. In the laminated type, films of respective materials were stuck to each other to form a multi-layer structure; and in the mixed type, the composition distribution was controlled such that each component became rich at each stage.

TABLE 5

| | Negative | Nitrogen-containing | | Separator | | | | Capacity |
|---|---|---|---|---|---|---|---|---|
| | electrode | aromatic compound | | Positive | | Negative | | retention |
| | active | | Content | electrode | | electrode | | rate |
| | material | Kind | (% by weight) | side | Center | side | Type | (%) |
| Example 4-1 | Graphite | Formula | 1 | PP | PE | PP | Laminated | 93 |
| Example 4-2 | | (16-6) | | PVDF | PE | PVDF | Laminated | 93 |
| Example 4-3 | | | | PP | PE | PP | Mixed | 92 |
| Example 4-4 | | | | PVDF | PE | PVDF | Mixed | 92 |
| Example 4-5 | Graphite | — | — | PP | PE | PP | Laminated | 83 |
| Example 4-6 | | | | PVDF | PE | PVDF | Laminated | 83 |
| Example 4-7 | | | | PP | PE | PP | Mixed | 82 |
| Example 4-8 | | | | PVDF | PE | PVDF | Mixed | 82 |

Even when the configuration of the separator 23 was changed, the same results shown in Tables 1 and 2 were obtained. In particular, when the configuration of the separator 23 was made of a laminated type or a mixed type, the capacity retention rate became higher.

### Examples 5-1 to 5-14

Secondary batteries were fabricated in the same procedure as that in Example 1-17 or 1-46, except for changing the charge termination voltage, and their high-temperature characteristics were examined. As a result, results shown in Table 6 were obtained.

TABLE 6

| | Negative | Nitrogen-containing | | Charge | Charge |
|---|---|---|---|---|---|
| | electrode | aromatic compound | | termination | retention |
| | active | | Content | voltage | rate |
| | material | Kind | (% by weight) | (V) | (%) |
| Example 5-1 | Graphite | Formula | 1 | 4.25 | 90 |
| Example 5-2 | | (16-6) | | 4.30 | 89 |
| Example 5-3 | | | | 4.35 | 86 |
| Example 5-4 | | | | 4.40 | 81 |
| Example 5-5 | | | | 4.45 | 74 |
| Example 5-6 | | | | 4.50 | 63 |
| Example 5-7 | | | | 4.55 | 51 |
| Example 5-8 | Graphite | — | — | 4.25 | 80 |
| Example 5-9 | | | | 4.30 | 77 |
| Example 5-10 | | | | 4.35 | 73 |
| Example 5-11 | | | | 4.40 | 66 |
| Example 5-12 | | | | 4.45 | 57 |
| Example 5-13 | | | | 4.50 | 45 |
| Example 5-14 | | | | 4.55 | 28 |

Even when the charge termination voltage was changed, the same results shown in Tables 1 and 2 were obtained. In particular, when the electrolytic solution contained a nitrogen-containing aromatic compound, even by increasing the charge termination voltage, a high capacity retention rate was obtained.

### Examples 6-1 to 6-6

Secondary batteries were fabricated in the same procedure as that in Example 1-17 or 1-46, except for changing the kind of the negative electrode active material and the forming method of the negative electrode active material layer 22B, and their high-temperature characteristics were examined. As a result, results shown in Table 7 were obtained.

In the case of using Si as the negative electrode active material, silicon was deposited on the both surfaces of the negative electrode collector 22A (electrolytic copper foil: thickness=15 μm) by adopting an electron beam vapor deposition method, thereby forming the negative electrode active material layer 22B. In that case, the deposition step was repeated 10 times, thereby adjusting a thickness on one side of the negative electrode active material layer 22B to 6 μm.

Also, the negative electrode active material layer 22B was formed by adopting a coating method. In that case, the same procedure as that in the case of using graphite was followed, except that 90 parts by mass of a negative electrode active material (Si having a median diameter of 1 μm) and 10 parts by mass of a negative electrode binder (PVDF) were mixed to form a negative electrode mixture.

In the case of using an SnCoC-containing material (SnCoC) as the negative electrode active material, the negative electrode active material layer 22B was formed by adopting a coating method. In that case, a Co powder and an Sn powder were alloyed to form a CoSn alloy powder, to which was then added a C powder, followed by dry mixing. Subsequently, 10 g of the mixture was set together with about 400 g of steel balls having a diameter of 9 mm in a reaction vessel of a planetary ball mill, manufactured by Ito Seisakusho Co., Ltd. Subsequently, after displacing the inside of the reaction vessel into an argon atmosphere, an operation of rotation at a rotation rate of 250 rpm for 10 minutes and a pause for 10 minutes were repeated until a total sum of the operation time reached 20 hours. Subsequently, the reaction vessel was cooled to room temperature, and the reactant (SnCoC) was taken out and allowed to pass through a 280-mesh screen, thereby removing a coarse powder.

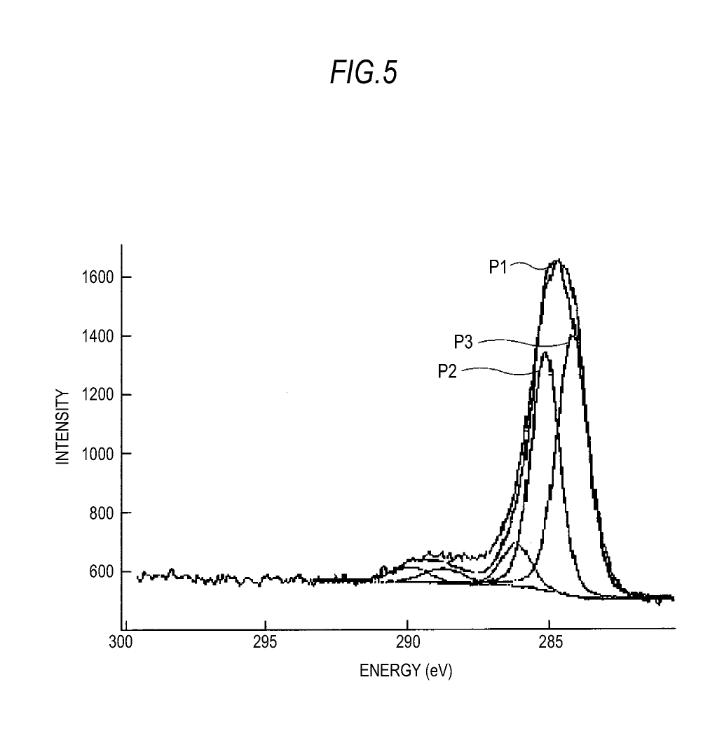

The analysis of a composition of the obtained SnCoC revealed that a content of Sn was 49.5% by mass, a content of Co was 29.7% by mass, a content of C was 19.8% by mass, and a proportion of Sn and Co (Co/(Sn+Co)) was 37.5% by mass. On that occasion, the content of each of Sn and Co was measured by means of inductively coupled plasma (ICP) emission analysis, and the content of C was measured by a carbon/sulfur analyzer. Also, as a result of analysis of the SnCoC-containing material by means of X-ray diffraction, a diffraction peak having a half width was observed in the range of from 20° to 50° in terms of 2θ. Furthermore, as a result of analysis of SnCoC by means of XPS, a peak P1 was obtained as shown in FIG. 5. As a result of analysis of this peak P1, a peak P2 of surface contamination carbon and a peak P3 of C1s in SnCoC on the lower energy side than the preceding (region lower than 284.5 eV) were obtained. From this result, it was confirmed that C in SnCoC bonded to other element.

After obtaining SnCoC, 80 parts by mass of the negative electrode active material (SnCoC), 8 parts by mass of a negative electrode binder (PVDF), and 12 parts by mass of a negative electrode electrically conductive agent (graphite and acetylene black) (graphite=11 parts by mass and acetylene black=1 part by mass) were mixed to form a negative electrode mixture. Subsequently, the negative electrode mixture was dispersed in NMP to form a negative electrode mixture slurry in a paste form. Finally, the negative electrode mixture slurry was uniformly coated on the both surfaces of a negative electrode collector 22A (strip-shaped electrolytic copper foil: thickness=15 μm) by a coating apparatus and then dried, thereby forming a negative electrode active material layer 22B. Thereafter, the negative electrode active material layer 22B was subjected to compression molding by a roll press.

TABLE 7

| | | Nitrogen-containing | | Capacity |
|---|---|---|---|---|
| | Negative electrode | aromatic compound | | retention |
| | active material | | Content | rate |
| | (Forming method) | Kind | (% by weight) | (%) |
| Example 6-1 | Si | Formula | 1 | 88 |
| | (Electron beam | (16-6) | | |
| | vapor deposition | | | |
| | method) | | | |
| Example 6-2 | Si | | | 84 |
| | (Coating method) | | | |
| Example 6-3 | SnCoC | | | 90 |
| | (Coating method) | | | |
| Example 6-4 | Si | — | — | 77 |
| | (Electron beam | | | |
| | vapor deposition | | | |
| | method) | | | |
| Example 6-5 | Si | | | 73 |
| | (Coating method) | | | |
| Example 6-6 | SnCoC | | | 79 |
| | (Coating method) | | | |

Even by using a metal based material (Si or SnCoC) as the negative electrode active material, the same results as those in the case of using a carbon material (see Tables 1 and 2) were obtained. In particular, when the metal based material was used, an increase rate of the capacity retention rate became large as compared with that in the case of using the carbon material (graphite).

From the results shown in Tables 1 to 7, it is noted that when the electrolytic solution contains the foregoing nitrogen-containing aromatic compound, an excellent cycle characteristic is obtained even in the high-temperature environment, and therefore, the high-temperature characteristics are enhanced.

While the present technology has been described with reference to the embodiments and working examples, it should not be construed that the present technology is limited to the foregoing embodiments and working examples, but various modifications can be made. For example, the positive electrode active material of the present technology is similarly applicable to a lithium ion secondary battery in which a capacity of a negative electrode includes a capacity due to intercalation and deintercalation of a lithium ion and a capacity following deposition and dissolution of a lithium metal and is expressed by a total sum of those capacities. In that case, the lithium ion secondary battery is designed in such a manner that a chargeable capacity of the negative electrode material is smaller than a discharge capacity of the positive electrode.

Also, in the embodiments and working examples, while the present technology has been described by reference to the case where the battery structure is of a cylindrical type or a laminated film type, or the case where the battery element has a wound structure, it should not be construed that the present technology is limited thereto. The lithium ion secondary battery of the present technology is similarly applicable to the case where the secondary battery has other battery structure such as a coin type, a rectangular type, and a button type, or the case where the battery element has other structure such as a laminated structure.

The present disclosure contains subject matter related to that disclosed in Japanese Priority Patent Application JP 2011-110723 filed in the Japan Patent Office on May 17, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A secondary battery comprising:
a positive electrode,
a negative electrode, and
an electrolytic solution containing a nitrogen-containing aromatic compound, wherein
the nitrogen-containing compound contains an aromatic skeleton containing one or two or more aromatic rings and one or two or more nitrogen-containing functional groups bonded to the one or two or more aromatic rings and represented by the following formula (1)
(XX═N— (1)
wherein X represents C or P; Y represents a group constituted of one kind or two or more kinds of elements selected from the group consisting of H, C, N, O, S, F, Cl, Br, and I, provided that arbitrary two or more of X and Y may be bonded to each other to form a ring structure; and z is 2 or 3.

2. The secondary battery according to claim 1, wherein the aromatic skeleton is a member selected from the group consisting of naphthalene, biphenyl, phenanthrene, fluorene, and heterofluorene.

3. The secondary battery according to claim 1, wherein Y in the formula (1) is an electron donating group.

4. The secondary battery according to claim 3, wherein Y in the formula (1) is at least one of a dialkylamino group and an aryl group.

5. The secondary battery according to claim 1, wherein the number of nitrogen-containing functional groups is 2 or more.

6. The secondary battery according to claim 1, wherein
the aromatic ring contains two or more rings, and one or more nitrogen-containing functional groups are bonded to every ring of at least two rings of the two or more rings, and
a value counted from a carbon atom in the ring to which one of the nitrogen-containing functional groups is bonded to a carbon atom in other ring to which the other nitrogen-containing function group is bonded such that the number of carbon atoms becomes the smallest is 2 or more and not more than 4.

7. The secondary battery according to claim 1, wherein the nitrogen-containing aromatic compound contains at least one of compounds represented by the following formulae (2) to (5) 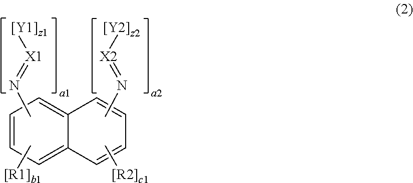
wherein each of X1 and X2 represents C or P; each of Y1, Y2, R1, and R2 represents a group constituted of one kind or two or more kinds of elements selected from the group consisting of H, C, N, O, S, F, Cl, Br, and I, provided that arbitrary two or more of X1, X2, Y1, Y2, R1, and R2 may be bonded to each other to form a ring structure; each of z1 and z2 is 2 or 3; and each of a1, a2, b1, and c1 represents an integer and is satisfied with relationships of a1≧0, a2≧0, b1≧0, and c1≧0, respectively, provided that (a1+a2)≧1, 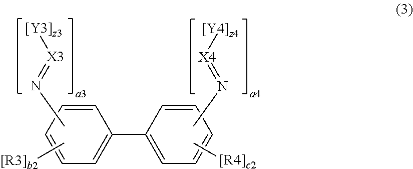
wherein each of X3 and X4 represents C or P; each of Y3, Y4, R3, and R4 represents a group constituted of one kind or two or more kinds of elements selected from the group consisting of H, C, N, O, S, F, Cl, Br, and I, provided that arbitrary two or more of X3, X4, Y3, Y4, R3, and R4 may be bonded to each other to form a ring structure; each of z3 and z4 is 2 or 3; and each of a3, a4, b2, and c2 represents an integer and is satisfied with relationships of a3≧0, a4≧0, b2≧0, and c2≧0, respectively, provided that (a3+a4)≧1, 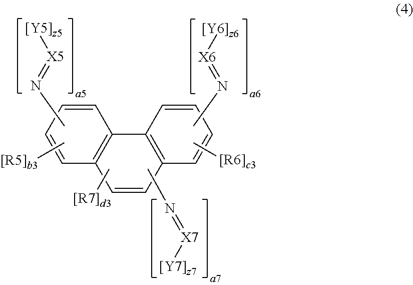
wherein each of X5 to X7 represents C or P; each of Y5 to Y7 and R5 to R7 represents a group constituted of one kind or two or more kinds of elements selected from the group consisting of H, C, N, O, S, F, Cl, Br, and I, provided that arbitrary two or more of X5 to X7, Y5 to Y7, and R5 to R7 may be bonded to each other to form a ring structure; each of z5 to z7 is 2 or 3; and each of a5 to a7, b3, c3, and d3 represents an integer and is satisfied with relationships of a5≧0, a6≧0, a7≧0, b3≧0, c3≧0, d3≧3, respectively, provided that (a5+a6+a7)≧1, and 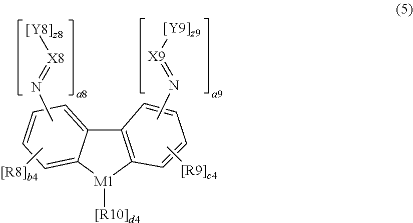
wherein each of X8 and X9 represents C or P; each of Y8, Y9, and R8 to R10 represents a group constituted of one kind or two or more kinds of elements selected from the group consisting of H, C, N, O, S, F, Cl, Br, and I, provided that arbitrary two or more of X8, X9, Y8, Y9, and R8 to R10 may be bonded to each other to form a ring structure; M1 represents C, O, S, Se, or Te; each of z8 and z9 is 2 or 3; and each of a8, a9, b4, c4, and d4 represents an integer and is satisfied with relationships of a8≧0, a9≧0, b4≧0, c4≧0, and d4≧0, respectively, provided that (a8+a9)≧1.

8. The secondary battery according to claim 1, wherein the nitrogen-containing aromatic compound contains at least one of compounds represented by the following formulae (6) to (13) 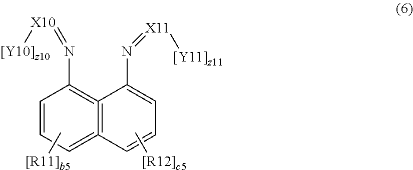
wherein each of X10 and X11 represents C or P; each of Y10, Y11, R11, and R12 represents a group constituted of one kind or two or more kinds of elements selected from the group consisting of H, C, N, O, S, F, Cl, Br, and I, provided that arbitrary two or more of X10, X11, Y10, Y11, R11, and R12 may be bonded to each other to form a ring structure; each of z10 and z11 is 2 or 3; and each of b5 and c5 represents an integer and is satisfied with relationships of b5≧0 and c5≧0, 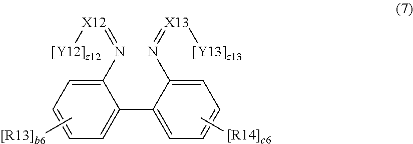
wherein each of X12 and X13 represents C or P; each of Y12, Y13, R13, and R14 represents a group constituted of one kind or two or more kinds of elements selected from the group consisting of H, C, N, O, S, F, Cl, Br, and I, provided that arbitrary two or more of X12, X13, Y12, Y13, R13, and R14 may be bonded to each other to form a ring structure; each of z12 and z13 is 2 or 3; and each of b6 and c6 represents an integer and is satisfied with relationships of b6≧0 and c6≧0, 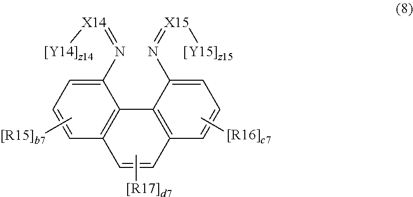
wherein each of X14 and X15 represents C or P; each of Y14, Y15, and R15 to R17 represents a group constituted of one kind or two or more kinds of elements selected from the group consisting of H, C, N, O, S, F, Cl, Br, and I, provided that arbitrary two or more of X14, X15, Y14, Y15, and R15 to R17 may be bonded to each other to form a ring structure; each of z14 and z15 is 2 or 3; and each of b7, c7, and d7 represents an integer and is satisfied with relationships of b7≧0, c7≧0, and d7≧0, 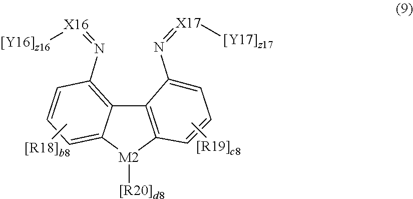
wherein each of X16 and X17 represents C or P; each of Y16, Y17, and R18 to R20 represents a group constituted of one kind or two or more kinds of elements selected from the group consisting of H, C, N, O, S, F, Cl, Br, and I, provided that arbitrary two or more of X16, X17, Y16, Y17, and R18 to R20 may be bonded to each other to form a ring structure; M2 represents C, O, S, Se, or Te; each of z16 and z17 is 2 or 3; and each of b8, c8, and d8 represents an integer and is satisfied with relationships of b8≧0, c8≧0, and d8≧0, 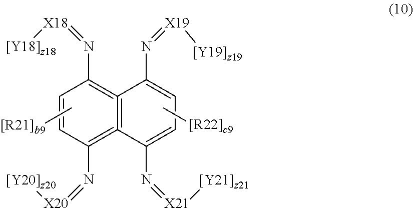
wherein each of X18 to X21 represents C or P; each of Y18 to Y21, R21, and R22 represents a group constituted of one kind or two or more kinds of elements selected from the group consisting of H, C, N, O, S, F, Cl, Br, and I, provided that arbitrary two or more of X18 to X21, Y18 to Y21, R21, and R22 may be bonded to each other to form a ring structure; each of z18 to z21 is 2 or 3; and each of b9 and c9 represents an integer and is satisfied with relationships of b9≧0 and c9≧0, 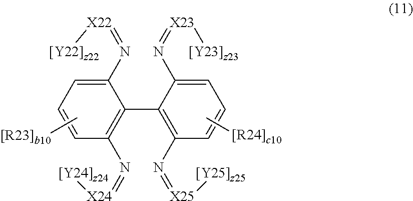
wherein each of X22 to X25 represents C or P; each of Y22 to Y25, R23, and R24 represents a group constituted of one kind or two or more kinds of elements selected from the group consisting of H, C, N, O, S, F, Cl, Br, and I, provided that arbitrary two or more of X22 to X25, Y22 to Y25, R23, and R24 may be bonded to each other to form a ring structure; each of z22 to z25 is 2 or 3; and each of b10 and c10 represents an integer and is satisfied with relationships of b10≧0 and c10≧0, 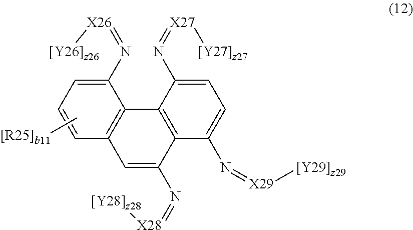
wherein each of X26 to X29 represents C or P; each of Y26 to Y29 and R25 represents a group constituted of one kind or two or more kinds of elements selected from the group consisting of H, C, N, O, S, F, Cl, Br, and I, provided that arbitrary two or more of X26 to X29, Y26 to Y29, and R25 may be bonded to each other to form a ring structure; each of z26 to z29 is 2 or 3; and b11 represents an integer and is satisfied with relationships of b11≧0, and 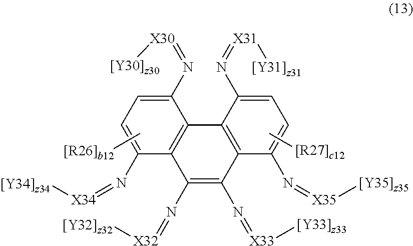
wherein each of X30 to X35 represents C or P; each of Y30 to Y35, R26, and R27 represents a group constituted of one kind or two or more kinds of elements selected from the group consisting of H, C, N, O, S, F, Cl, Br, and I, provided that arbitrary two or more of X30 to X35, Y30 to Y35, R26, and R27 may be bonded to each other to form a ring structure; each of z30 to z35 is 2 or 3; and each of b12 and c12 represents an integer and is satisfied with relationships of b12≧0 and c12≧0.

9. The secondary battery according to claim 1, wherein a content of the nitrogen-containing aromatic compound in the electrolytic solution is 0.001% by weight or more and not more than 10% by weight.

10. The secondary battery according to claim 1, wherein the electrolytic solution contains a nonaqueous solvent, and the nonaqueous solvent contains, as a halogenated cyclic carbonate, at least one of 4-fluoro-1,3-dioxolan-2-one and 4,5-difluoro-1,3-dioxolan-2-one.

11. The secondary battery according to claim 10, wherein a content of the halogenated cyclic carbonate in the nonaqueous solvent is 0.01% by weight or more and not more than 30% by weight.

12. The secondary battery according to claim 1, wherein
the positive electrode and the negative electrode are laminated via a separator containing a polymer compound, and
the separator has a multi-layer structure composed of a laminate of two or more kinds of polymer compounds in the thickness direction, or a single-layer structure composed of two or more kinds of polymer compounds having a different composition from each other in the thickness direction.

13. The secondary battery according to claim 12, wherein the polymer compound contains at least one member selected from the group consisting of polyethylene, polypropylene, polyvinylidene fluoride, polytetrafluoroethylene, aramid, polyamide-imide, polyamide, polyimide, polyether imide, and polyacrylonitrile.

14. The secondary battery according to claim 1, wherein an open circuit voltage in a fully charged state is 4.25 V or more and not more than 6.00 V.

15. The secondary battery according to claim 1, which is a lithium ion secondary battery.

16. An electrolytic solution for secondary battery comprising a nitrogen-containing aromatic compound, wherein
the nitrogen-containing compound contains an aromatic skeleton containing one or two or more aromatic rings and one or two or more nitrogen-containing functional groups bonded to the one or two or more aromatic rings and represented by the following formula (1)
(YX═N— (1)
wherein X represents C or P; Y represents a group constituted of one kind or two or more kinds of elements selected from the group consisting of H, C, N, O, S, F, Cl, Br, and I, provided that arbitrary two or more of X and Y may be bonded to each other to form a ring structure; and z is 2 or 3.

17. An electronic appliance comprising the secondary battery according to claim 1.

18. A power tool comprising the secondary battery according to claim 1.

19. An electric vehicle comprising the secondary battery according to claim 1.

20. An electric power storage system comprising the secondary battery according to claim 1.
